(19) United States
(12) Patent Application Publication
(10) Pub. No.: US 2026/0216661 A1
(43) Pub. Date: Jul. 30, 2026

(54) Polymeric Hollow Fiber Membrane Having A Crosslinked Selective Layer, Carbon Molecular Sieve Hollow Fiber Membrane, And Methods For Preparing The Same

(71) Applicant: SOGANG UNIVERSITY RESEARCH & BUSINESS DEVELOPMENT FOUNDATION, Seoul (KR)

(72) Inventors: Jong Suk LEE, Seoul (KR); Hyun Jung YU, Gyeonggi-do (KR); Heseong AN, Chungcheongbuk-do (KR); Ju Ho SHIN, Seoul (KR)

(21) Appl. No.: 19/629,642

(22) Filed: Mar. 26, 2026

Related U.S. Application Data
(62) Division of application No. 18/480,818, filed on Oct. 4, 2023.

(30) Foreign Application Priority Data
Oct. 6, 2022 (KR) 10-2022-0127498

(51) Int. Cl. B01D 69/08; B01D 53/22; B01D 67/00; B01D 69/02; B01D 69/10; B01D 71/02; B01D 71/64

(52) U.S. Cl. CPC B01D 69/087; B01D 53/228; B01D 67/0006; B01D 67/0083; B01D 69/02; B01D 69/107; B01D 71/021; B01D 71/64; B01D 2053/224; B01D 2323/219; B01D 2323/30; B01D 2323/36; B01D 2325/04

(57) ABSTRACT

A polymeric hollow fiber membrane is provided having a crosslinked selective layer formed by sequentially performing coating of a polymer precursor on a crosslinked polymeric hollow fiber membrane support and thermal condensation and thermal crosslinking thereof, a carbon molecular sieve hollow fiber membrane, methods for producing the same, and methods of separating gases using the same. The polymeric hollow fiber membrane and the carbon molecular sieve hollow fiber membrane each have a thin crosslinked selective layer and excellent plasticization resistance and separation performance. Accordingly, the polymeric hollow fiber membrane and the carbon molecular sieve hollow fiber membrane, each of which has a thin crosslinked selective layer, can be effectively used in the separation of a mixed gas.

### CROSS REFERENCE TO RELATED APPLICATIONS

This application is a divisional of U.S. patent application Ser. No. 18/480,818 filed Oct. 4, 2023, which claims priority to Korean patent application no. 10-2022-0127498 filed on Oct. 6, 2022, all of which are expressly incorporated by reference herein in their entireties.

### BACKGROUND

### Technical Field

The present invention relates to a polymeric hollow fiber membrane having a crosslinked selective layer formed by sequentially performing coating of a polymer precursor on a crosslinked polymeric hollow fiber membrane support and thermal condensation and thermal crosslinking thereof, a carbon molecular sieve hollow fiber membrane, methods for producing the same, and methods of separating gases using the same. Specifically, the present invention relates to a polymeric hollow fiber membrane having a crosslinked selective layer formed by coating a polyimide precursor solution on a crosslinked polymeric hollow fiber membrane support comprising a glassy polymer and a ladder-structured polysilsesquioxane and subjecting it to a thermal condensation and thermal crosslinking, a carbon molecular sieve hollow fiber membrane, methods for producing the same, and methods of separating gases using the same.

### Related Art

In recent years, the demand for energy is rapidly increasing in tandem with the economic development of such developing countries as China, India, and the like. In particular, natural gas plays a major role as an energy source. However, since natural gas generally contains nitrogen to some extent, it is necessary to improve the quality of natural gas by lowering it to a certain content (e.g., 3%) or less. In addition, the concentration of impurities such as carbon dioxide, nitrogen, and C2-C4 hydrocarbons must be removed below a certain level for the transportation of natural gas. According to the U.S. Pipeline Specifications, the concentration of carbon dioxide and nitrogen is stipulated to be lowered to 2% and 4% or less, respectively.

In general, nitrogen is removed using cryogenic distillation in large-scale refining of natural gas, which is expensive and uneconomical for small-scale refining of natural gas. As a technology for removing nitrogen from natural gas in a small scale, a pressure swing adsorption (PSA) process capable of selectively adsorbing/removing nitrogen alone or a separation membrane technology that selectively passes nitrogen alone is attracting attention. In particular, if impurities such as nitrogen and carbon dioxide are selectively passed through and methane is collected as a retentate, the recompression step is not required, whereby the process costs can be reduced.

The membrane process is advantageous in terms of relatively low energy consumption and costs. However, if a gas with high condensability such as CO₂ is present in the feed gas at a high pressure, the separation membrane is plasticized, thereby reducing its selectivity of gases. Crosslinked membranes have been developed to suppress the plasticization of polymer membranes. However, crosslinking of polyimide using an amine crosslinking agent has a problem in that the free volume decreases, which reduces the CO₂ permeability, and crosslinked membranes using bromination/debromination have poor process efficiency because polyimide has to undergo bromination and debromination (see J. Membr. Sci. 2008, 312, 174-185 and J. Membr. Sci. 2018, 545, 358-366).

It is difficult to coat polymers that are soluble in polar aprotic solvents such as n-methyl-2-pyrrolidone and dimethylformamide on a polymeric hollow fiber membrane support using the conventional dip-coating methods adopted in the production of membranes due to the weak chemical resistance of the support. Thus, to date, most hollow fiber membranes manufactured by dip-coating on polymer supports have been limited to rubbery polymers, such as Pebax 1657© and poly(dimethyl)siloxane, which are soluble in water, ethanol, or hexane.

### PRIOR ART DOCUMENTS

### Non-Patent Document

(Non-patent Document 1) J. Membr. Sci. 2008, 312, 174-185
(Non-patent Document 2) J. Membr. Sci. 2018, 545, 358-366
(Non-patent Document 3) J. Mater. Chem. A. 2017, 5, 7732-7737
(Non-patent Document 4) J. Membr. Sci. 2017, 524, 266-279
(Non-patent Document 5) Sep. Purif Technol. 2015, 146, 85-93

### SUMMARY

An object of the present invention is to provide a method for preparing a polymeric hollow fiber membrane and a carbon molecular sieve hollow fiber membrane, each of which has a thin crosslinked selective layer and excellent plasticization resistance and separation performance.

Another object of the present invention is to provide a polymeric hollow fiber membrane and a carbon molecular sieve hollow fiber membrane, each of which is prepared by the above method and has a thin crosslinked selective layer and excellent plasticization resistance and separation performance.

Another object of the present invention is to provide a method for separating a mixed gas using each of the hollow fiber membranes.

According to an embodiment of the present invention, there is provided a method for preparing a polymeric hollow fiber membrane having a crosslinked selective layer, which comprises (1) dissolving a polymer composition comprising 70 to 95% by weight of a glassy polymer having a first functional group and 5 to 30% by weight of a ladder-structured polysilsesquioxane having a second functional group capable of reacting with the first functional group in an organic solvent to prepare a polymer solution; (2) spinning the polymer solution obtained in step (1) and a bore fluid through a spinneret to form a polymeric hollow fiber membrane precursor; (3) thermally treating the polymeric hollow fiber membrane precursor obtained in step (2) to form a crosslinked polymeric hollow fiber membrane support; (4) coating a polyimide precursor solution on the surface of the crosslinked polymeric hollow fiber membrane support obtained in step (3); and (5) drying the polymeric hollow fiber membrane support coated in step (4) and thermally condensing and thermally crosslinking it.

According to another embodiment of the present invention, there is provided a polymeric hollow fiber membrane having a crosslinked selective layer, which is prepared by the above method and comprises a crosslinked polymeric hollow fiber membrane support prepared from a polymer composition comprising 70 to 95% by weight of a glassy polymer having a first functional group and 5 to 30% by weight of a ladder-structured polysilsesquioxane having a second functional group capable of reacting with the first functional group and a selective layer formed on the support by thermal condensation and thermal crosslinking of a polyimide precursor solution.

According to another embodiment of the present invention, there is provided a method for preparing a carbon molecular sieve hollow fiber membrane having a crosslinked selective layer, which comprises (1) dissolving a polymer composition comprising 70 to 95% by weight of a glassy polymer having a first functional group and 5 to 30% by weight of a ladder-structured polysilsesquioxane having a second functional group capable of reacting with the first functional group in an organic solvent to prepare a polymer solution; (2) spinning the polymer solution obtained in step (1) and a bore fluid through a spinneret to form a polymeric hollow fiber membrane precursor; (3) thermally treating the polymeric hollow fiber membrane precursor obtained in step (2) to form a crosslinked polymeric hollow fiber membrane support; (4) coating a polyimide precursor solution on the surface of the crosslinked polymeric hollow fiber membrane support obtained in step (3); (5) drying the polymeric hollow fiber membrane support coated in step (4) and thermally condensing and thermally crosslinking it to obtain a polymeric hollow fiber membrane having a crosslinked selective layer; and (6) pyrolyzing the polymeric hollow fiber membrane having a crosslinked selective layer obtained in step (5).

According to another embodiment of the present invention, there is provided a carbon molecular sieve hollow fiber membrane, which is prepared by the above method and comprises a carbonized product of a polymeric hollow fiber membrane having a crosslinked selective layer, which comprises a crosslinked polymeric hollow fiber membrane support prepared from a polymer composition comprising 70 to 95% by weight of a glassy polymer having a first functional group and 5 to 30% by weight of a ladder-structured polysilsesquioxane having a second functional group capable of reacting with the first functional group and a selective layer formed on the support by thermal condensation and thermal crosslinking of a polyimide precursor solution.

According to another embodiment of the present invention, there is provided a method for separating gases, which comprises passing a mixed gas containing at least two types of gases through the polymeric hollow fiber membrane or the carbon molecular sieve hollow fiber membrane, each of which has a crosslinked selective layer according to an embodiment of the present invention to remove at least a portion of at least one type of the gases.

### Advantages Effects of the Invention

The preparation method according to an embodiment of the present invention can provide a polymeric hollow fiber membrane and a carbon molecular sieve hollow fiber membrane, each of which has a thin crosslinked selective layer and excellent plasticization resistance and separation performance.

The polymeric hollow fiber membrane and the carbon molecular sieve hollow fiber membrane each have a thin crosslinked selective layer and excellent plasticization resistance and separation performance. Accordingly, the polymeric hollow fiber membrane and the carbon molecular sieve hollow fiber membrane, each of which has a thin crosslinked selective layer, can be effectively used in the separation of a mixed gas.

### BRIEF DESCRIPTION OF THE DRAWINGS

FIGS. 1(a) to 1(f) show SEM images of the cross-section (a) and surface (b) of a polymeric hollow fiber membrane precursor before thermal treatment, the surface (c) thereof after thermal treatment, the pore size distribution before and after thermal treatment (d), and AFM images of the surface thereof before thermal treatment (e) and after thermal treatment (f).

FIG. 2(a) is a graph showing the viscosity and surface tension of a polyamic acid solution of BTDA-Durene:DABA (3:2) with respect to reaction time.

FIG. 2(b) shows SEM images of the surface of a crosslinked polymeric hollow fiber membrane and the surface of the crosslinked polymeric hollow fiber membrane after coating with BTDA-Durene:DABA (3:2) with respect to the reaction time of the polyamic acid solution.

FIGS. 3(a) to 3(d) shows SEM images of the cross-section of polymeric hollow fiber membranes coated with a polyamic acid solution reacted for (a) 30 minutes, (b) 60 minutes, and (c) 120 minutes, and (d) a polymeric hollow fiber membrane coated with a polyimide solution. Thickness of the selective layer with respect to the axial position of the hollow fiber membrane: (a-1, b-1, c-1, d-1) 0-4 cm, (a-2, b-2, c-2, d-2) 4-8 cm, (a-3, b-3, c-3, d-3) 8-12 cm.

FIGS. 4(a) to 4(d) show SEM images of the cross-section of polymeric hollow fiber membranes having a crosslinked selective layer formed from a coating of a polyamic acid solution reacted for (a) 30 minutes, (b) 60 minutes, and (c) 120 minutes, and (d) a polymeric hollow fiber membrane obtained by thermal condensation of a polymeric hollow fiber membrane having a crosslinked selective layer formed from a coating of a polyimide solution. Thickness of the selective layer with respect to the axial position of the hollow fiber membrane: (a-1, b-1, c-1, d-1) 0-4 cm, (a-2, b-2, c-2, d-2) 4-8 cm, (a-3, b-3, c-3, d-3) 8-12 cm.

FIGS. 5(a) to 5(h) show SEM images of the surface of a polymeric hollow fiber membrane having crosslinked selective layer of BTDA-Durene:DABA (3:2) taken at an axial position of 4-8 cm. The surface of a polymeric hollow fiber membrane coated with a polyamic acid solution reacted for (a) 30 minutes, (b) 60 minutes, and (c) 120 minutes, and (d) a polymeric hollow fiber membrane coated with a polyimide solution; and the surface of a polymeric hollow fiber membrane having a crosslinked selective layer formed by thermally condensing and thermally crosslinking it at 370° C. (coating of a polyamic acid solution reacted for (a) 30 minutes, (b) 60 minutes, and (c) 120 minutes) and a polymeric hollow fiber membrane having a crosslinked selective layer formed from a polyimide coating.

FIGS. 6(a) and 6(b) show a polymeric hollow fiber membrane having a crosslinked selective layer formed by coating with a polyamic acid solution polymerized at 0° C. under a nitrogen purge and then thermally condensing and thermally crosslinking it. SEM images of (a) the cross-section and (b) surface of the hollow fiber membrane taken at an axial position of 4-8 cm.

FIGS. 7(a) to 7(f) show SEM images of the cross-section of polymeric hollow fiber membranes, before crosslinking, coated at a withdrawing rate of (a) 0.83 mm/s, (b) 2.5 mm/s, and (c) 5 mm/s; and SEM images of the surface of a polymeric hollow fiber membrane, after crosslinking, coated at a withdrawing rate of (a) 0.83 mm/s, (b) 2.5 mm/s, and (c) 5 mm/s.

FIGS. 8(a) to 8(c) show a polymeric hollow fiber membrane obtained by coating 6FDA-Durene:DABA (3:2) on a crosslinked polymeric hollow fiber membrane support of 6FDA-Durene:DABA (3:2)/LPDA64 (90/10 w/w) at a withdrawing rate of 0.83 mm/s and an immersion time of 1 minute and crosslinking it. SEM images (a-1), F EDX-mapping images (a-2), Si EDX-mapping images (a-3), and F and Si distribution images (a-4) of the cross-section of the hollow fiber membrane taken at an axial position of 4-8 cm. They show a polymeric hollow fiber membrane coated at a withdrawing rate of 5 mm/s and an immersion time of 3 minutes and crosslinked. SEM images (b-1), F EDX-mapping images (b-2), Si EDX-mapping images (b-3), and F and Si distribution images (b-4) of the cross-section of a hollow fiber membrane taken at an axial position of 4-8 cm. They show a polymeric hollow fiber membrane coated at a withdrawing rate of 5 mm/s and an immersion time of 1 minute and crosslinked. SEM images (c-1), F EDX-mapping images (c-2), Si EDX-mapping images (c-3), and F and Si distribution images (c-4) of the cross-section of the hollow fiber membrane taken at an axial position of 4-8 cm.

FIGS. 9(a) to 9(j) shows SEM images of the cross-section of a polymeric hollow fiber membrane with a coating of 6FDA-Durene:DABA (3:2) taken at an axial position of 4-8 cm. Polymeric hollow fiber membranes, before crosslinking, coated with a polyamic acid solution reacted for (a) 10 minutes, (b) 20 minutes, (c) 30 minutes, (d) 60 minutes, and (e) 120 minutes; and polymeric hollow fiber membranes, after crosslinking, coated with a polyamic acid solution reacted for (a) 10 minutes, (b) 20 minutes, (c) 30 minutes, (d) 60 minutes, and (e) 120 minutes and thermally treated at 370° C.

FIGS. 10(a) to 10(f) show SEM images of the surface of a polymeric hollow fiber membrane with a coating of 6FDA-Durene:DABA (3:2) taken at an axial position of 4-8 cm. Polymeric hollow fiber membranes, before crosslinking, coated with a polyamic acid solution reacted for (a) 30 minutes, (b) 60 minutes, and (c) 120 minutes; and polymeric hollow fiber membranes, after crosslinking, coated with a polyamic acid solution reacted for (d) 30 minutes, (e) 60 minutes, and (f) 120 minutes and thermally treated at 370° C.

FIGS. 11(a) and 11(b) show SEM images of (a) the cross-section and (b) surface of a carbon molecular sieve hollow fiber membrane obtained by carbonizing a hollow fiber membrane of 6FDA-Durene:DABA (3:2) at 550° C. The SEM images were taken at an axial position of 4-8 cm.

### DETAILED DESCRIPTION

Hereinafter, the present invention is explained in more detail.

### Process for Preparing a Polymeric Hollow Fiber Membrane Having Crosslinked Selective Layer

According to an embodiment of the present invention, there is provided a method for preparing a polymeric hollow fiber membrane having a crosslinked selective layer, which comprises (1) dissolving a polymer composition comprising 70 to 95% by weight of a glassy polymer having a first functional group and 5 to 30% by weight of a ladder-structured polysilsesquioxane having a second functional group capable of reacting with the first functional group in an organic solvent to prepare a polymer solution; (2) spinning the polymer solution obtained in step (1) and a bore fluid through a spinneret to form a polymeric hollow fiber membrane precursor; (3) thermally treating the polymeric hollow fiber membrane precursor obtained in step (2) to form a crosslinked polymeric hollow fiber membrane support; (4) coating a polyimide precursor solution on the surface of the crosslinked polymeric hollow fiber membrane support obtained in step (3); and (5) drying the polymeric hollow fiber membrane support coated in step (4) and thermally condensing and thermally crosslinking it.

### Step (1)

In step (1), a polymer composition comprising 70 to 95% by weight of a glassy polymer having a first functional group and 5 to 30% by weight of a ladder-structured polysilsesquioxane having a second functional group capable of reacting with the first functional group is dissolved in an organic solvent.

In a specific embodiment of the present invention, the glassy polymer having a first functional group may be a polyimide.

Specifically, the polyimide may be obtained by a known polycondensation reaction of an aromatic carboxylic dianhydride and an aromatic diamine. Thus, the polyimide may be a polyimide obtained by polycondensation of an aromatic carboxylic dianhydride and an aromatic diamine.

In a specific embodiment of the present invention, the aromatic carboxylic dianhydride that may be used in the synthesis of the polyimide may be at least one selected from the group consisting of 4,4′-hexafluoroisopropylidene)diphthalic anhydride (6FDA) having a structure of Formula 1(a) below, benzophenone-3,3′,4,4′-tetracarboxylic dianhydride (BTDA) having a structure of Formula 1(b) below, 4′4-oxydiphthalic dianhydride (ODPA) having a structure of Formula 1(c) below, pyromellitic dianhydride having a structure of Formula 1(d) below, 3,3′4,4′-biphenyltetracarboxylic dianhydride (BPDA) having a structure of Formula 1(e) below, 3,3′,4,4′-diphenylsulfonetetracarboxylic dianhydride having a structure of Formula 1(f) below, 3,4′-oxydiphthalic anhydride having a structure of Formula 1(g) below, dibromopyromellitic dianhydride having a structure of Formula 1(h) below, and naphthalene-1,4,5,8-tetracarboxylic dianhydride having a structure of Formula 1(i) below. But the aromatic carboxylic dianhydride is not particularly limited thereto. Preferably, the aromatic carboxylic dianhydride may be benzophenone-3,3′,4,4′-tetracarboxylic dianhydride (BTDA).

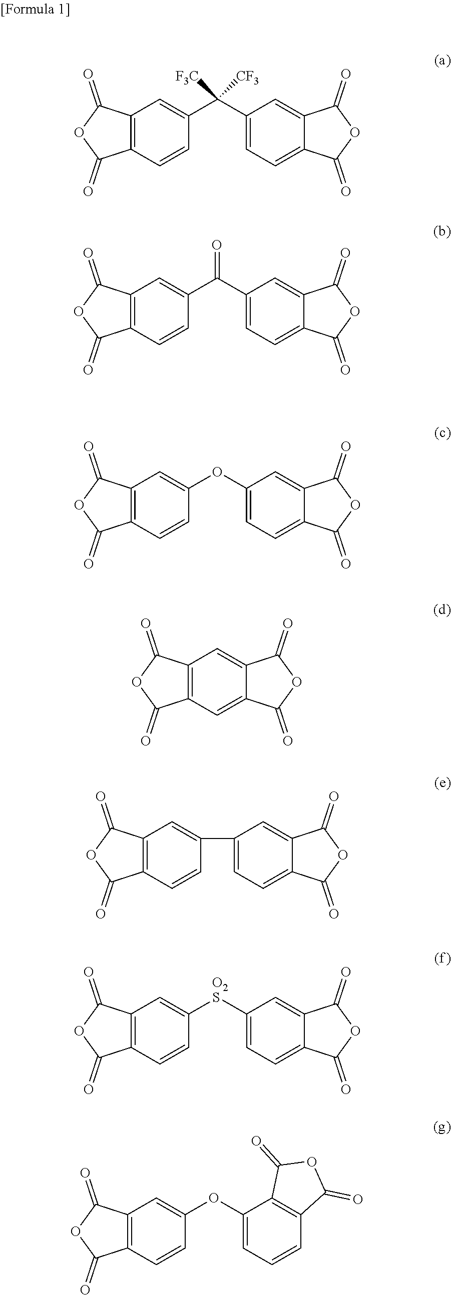

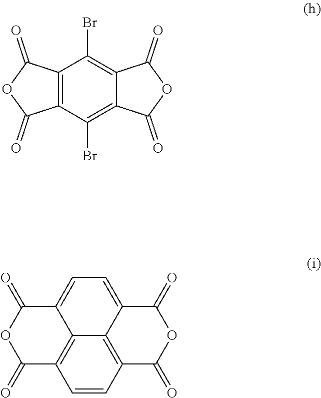 [SMILES: O=c1oc(=O)c2c(Br)c3c(=O)oc(=O)c3c(Br)c12 ; O=C1OC(=O)c2ccc3c4c(ccc1c24)C(=O)OC3=O]

In a specific embodiment of the present invention, the aromatic diamine that may be used in the synthesis of the polyimide may be at least one selected from the group consisting of 2,3,5,6-tetramethylene-1,4-phenylenediamine (Durene) having a structure of Formula 2(a) below, 3,5-diaminobenzoic acid (DABA) having a structure of Formula 2(b) below, 2,4,6-trimethyl-1,3-diaminobenzene (DAM) having a structure of Formula 2(c) below, 1,4-phenylenediamine having a structure of Formula 2(d) below, 1,3-phenylenediamine having a structure of Formula 2(e) below, 2,2-bis(4-aminophenyl)-hexafluoropropane having a structure of Formula 2(f) below, 2,3,5,6-tetrafluoro-1,4-phenylenediamine having a structure of Formula 2(g) below, and 4,4′-diaminophenyl ether having a structure of Formula 2(h) below. But the aromatic diamine is not particularly limited thereto. Preferably, the aromatic diamine may be a mixture of 2,3,5,6-tetramethylene-1,4-phenylenediamine (Durene) and 3,5-diaminobenzoic acid (DABA).

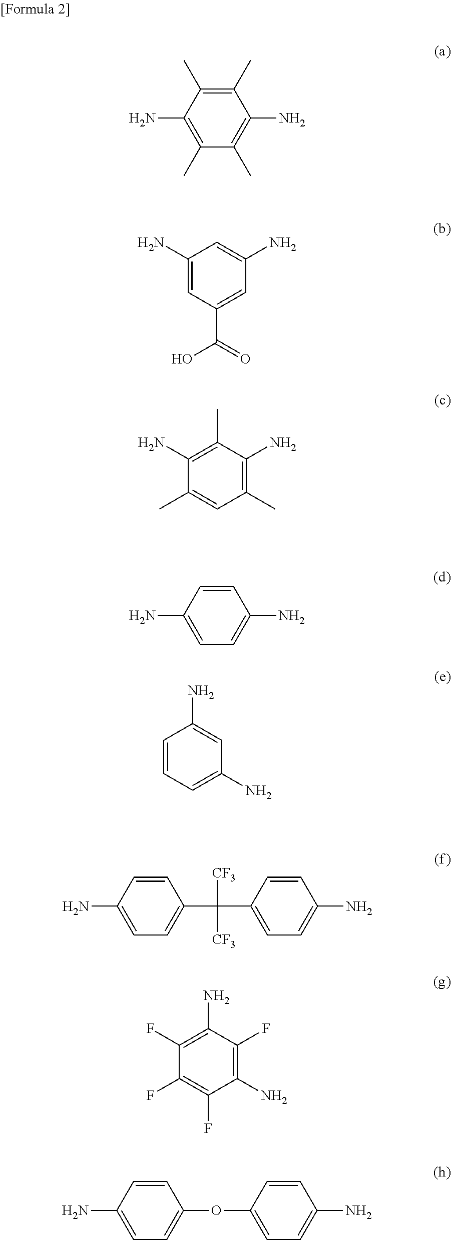

In a preferred example, the polyimide according to an embodiment of the present invention may be a polyimide (BTDA-Durene:DABA (3:2)) having a structure of Formula 3 below.

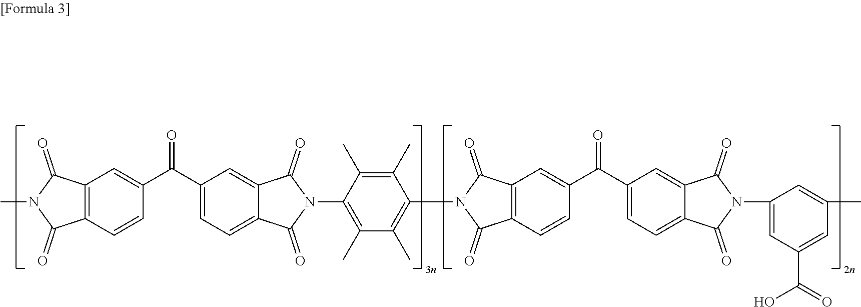

In Formula 3, n is an integer selected from 10² to 10⁴.

In the method for preparing a polymeric hollow fiber membrane having a crosslinked selective layer according to an embodiment of the present invention, the glassy polymer has a first functional group. Here, the first functional group is not particularly limited as long as it can react with a second functional group to be described below.

In a specific embodiment of the present invention, the first functional group may be at least one selected from the group consisting of an amine group and a carboxyl group. Preferably, the first functional group may be a carboxyl group.

In a specific embodiment of the present invention, the ladder-structured polysilsesquioxane having a second functional group capable of reacting with the first functional group may have a structure represented by Formula 4 below.

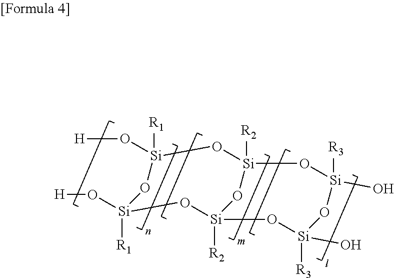

In Formula 4, R₁, R₂, and R₃ are each independently an organic functional group selected from the group consisting of aromatic phenyl, heteroaromatic phenyl, aliphatic alkyl, cycloaliphatic alkyl, vinyl, aryl, methacrylate, acrylate, and epoxy, at least one of which has a second function group, and n, m, and 1 are each an integer selected from 0 to 100.

The molar ratio of R₁:R₃ (i.e., n:l) may be 0.1:99.9 to 99.9:0.1, as expressed in terms of the copolymerization ratio of the organic functional groups in the ladder-structured polysilsesquioxane, and m may be 0. In addition, the molar ratio of R₂:R₃ (i.e., m:l) may be 0.1:99.9 to 99.9:0.1, and n may be 0.

Specifically, the molar ratio of R₁:R₃ may be 10:90 to 90:10, 20:80 to 80:20, 30:70 to 70:30, 50:50 to 70:30, or 55:45 to 65:35. More specifically, the molar ratio of R₁:R₃ may be about 6:4. Here, m may be 0. In addition, the molar ratio of R₂:R₃ may be 10:90 to 90:10, 20:80 to 80:20, 30:70 to 70:30, 50:50 to 70:30, or 55:45 to 65:35. More specifically, the molar ratio of R₂:R₃ may be about 6:4. Here, n may be 0.

In addition, the molar ratio of R₁:R₂:R₃ (i.e., n:m:l) may preferably be about 3:3:4, 3:4:3, or 4:3:3, but it is not limited thereto.

The polysilsesquioxane may have a number average molecular weight of 10² to 10⁸ g/mole, more specifically 10³ to 10⁷ or 10⁴ to 10⁶ g/mole.

In a specific embodiment of the present invention, the ladder-structured polysilsesquioxane may be selected from the group consisting of ladder-structured poly(phenyl-co-3-(2-aminoethylamino)propyl)silsesquioxane, ladder-structured poly(phenyl-co-methacryloxypropyl)silsesquioxane, ladder-structured poly(phenyl-co-glycidoxypropyl)silsesquioxane, ladder-structured poly(phenyl-co-pyridylethyl)silsesquioxane, ladder-structured poly(cyclohexyl-co-pyridylethyl)silsesquioxane, ladder-structured poly(cyclohexyl-co-phenyl-co-pyridylethyl)silsesquioxane, and a mixture thereof. But the ladder-structured polysilsesquioxane is not particularly limited thereto.

Preferably, the ladder-structured polysilsesquioxane may be at least one selected from the group consisting of ladder-structured poly(phenyl-co-3-(2-aminoethylamino)propyl)silsesquioxane (LPDA64) represented by the following Formula 4a in which R₁ and R₃ have a molar ratio of 6:4 in Formula 4; ladder-structured poly(phenyl-co-methacryloxypropyl)silsesquioxane (LPMA64) represented by the following Formula 4b wherein R₁ and R₃ have a molar ratio of 6:4 in Formula 4, ladder-structured poly(phenyl-co-glycidoxypropyl)silsesquioxane (LPG64) represented by the following Formula 4c wherein R₁ and R₃ have a molar ratio of 6:4 in Formula 4, ladder-structured poly(phenyl-co-pyridylethyl)silsesquioxane (LPPyr64) represented by the following Formula 4d wherein R₁ and R₃ have a molar ratio of 6:4 in Formula 4, ladder-structured poly(cyclohexyl-co-pyridylethyl)silsesquioxane (LCPyr64) represented by the following Formula 4e wherein R₁ and R₃ have a molar ratio of 6:4 in Formula 4, and ladder-structured poly(cyclohexyl-co-phenyl-co-pyridylethyl)silsesquioxane (LCPPyr334) represented by the following Formula 4f wherein R₁, R₂, and R₃ have a molar ratio of 3:3:4 in Formula 4.

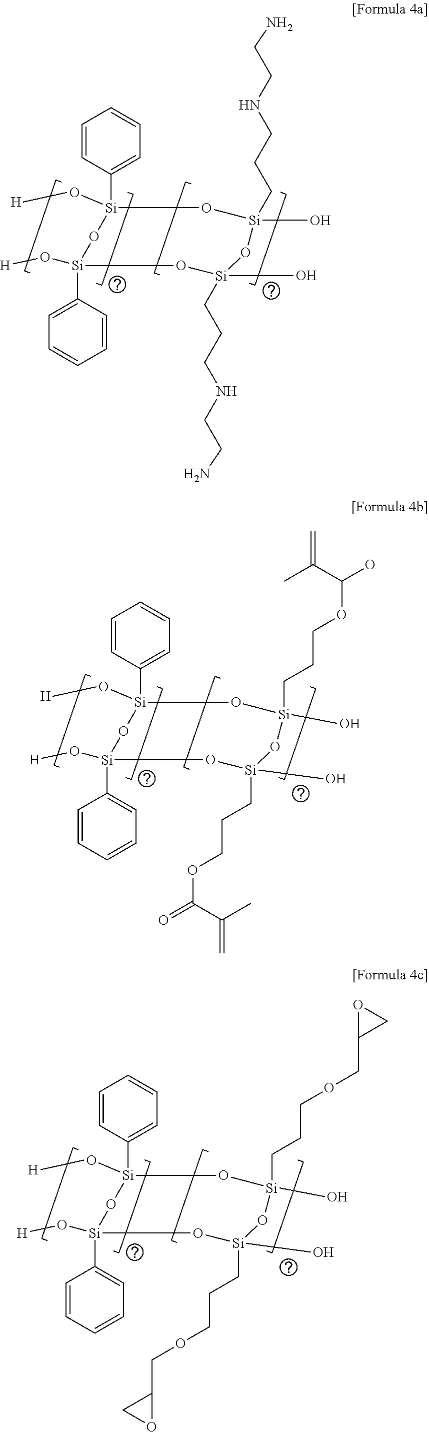

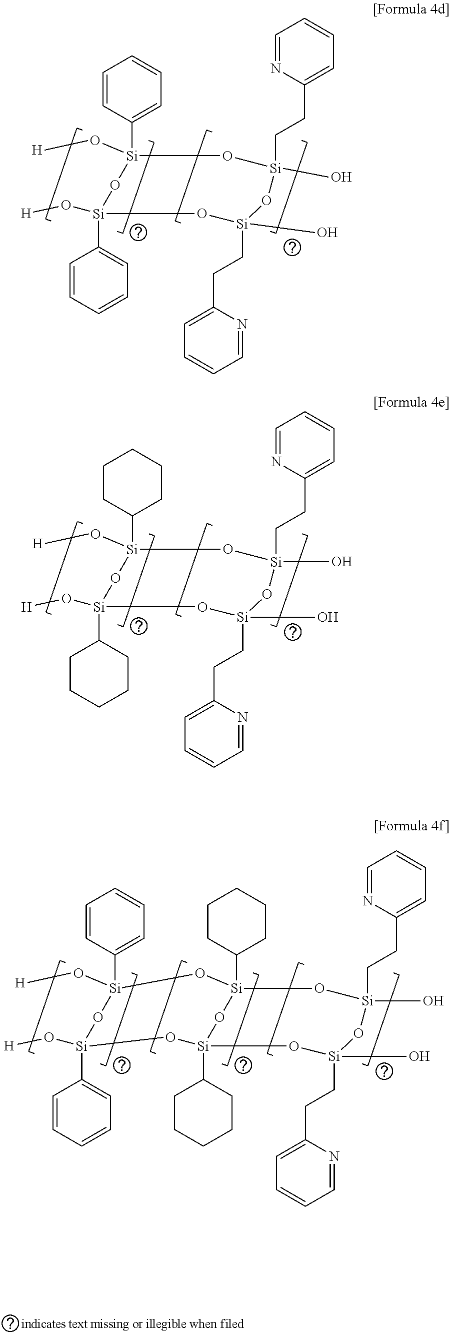

The ladder-structured polysilsesquioxane may be obtained by a known hydrolysis-condensation reaction of a silane monomer. Specifically, the ladder-structured polysilsesquioxane may be obtained by a known hydrolysis-condensation reaction of at least one selected from the group consisting of (a) an aliphatic monomer, (b) an aromatic monomer, and (c) a crosslinkable monomer.

In a specific embodiment of the present invention, the silane monomer may be at least one selected from the group consisting of [3-(2-aminoethylamino)propyl]trimethoxysilane, (3-bromopropyl)trimethoxysilane, (acetoxy)methyltrimethoxysilane, (phenyl)trimethoxysilane, ((chloromethyl)phenylethyl)trimethoxysilane, 2-(2-pyridylethyl)trimethoxysilane, (3-glycidoxypropyl)trimethoxysilane, (methacryloxypropyl)trimethoxysilane, and (butenyl)trimethoxysilane. But the silane monomer that can be used in the synthesis of the ladder-structured polysilsesquioxane is not particularly limited thereto.

Preferably, the aliphatic silane monomer that can be used in the synthesis of the ladder-structured polysilsesquioxane may comprise at least one of [3-(2-aminoethylamino)propyl]trimethoxysilane, (3-bromopropyl)trimethoxysilane, and (acetoxy)methyltrimethoxysilane as represented by the following Formula 5(a); the aromatic silane monomer may comprise at least one of (phenyl)trimethoxysilane, ((chloromethyl)phenylethyl)trimethoxysilane, and 2-(2-pyridylethyl)trimethoxysilane as represented by the following Formula 5(b); and the crosslinkable silane monomer may comprise at least one of (3-glycidoxypropyl)trimethoxysilane, (methacryloxypropyl)trimethoxysilane, and (butenyl)trimethoxysilane as represented by the following Formula 5(c).

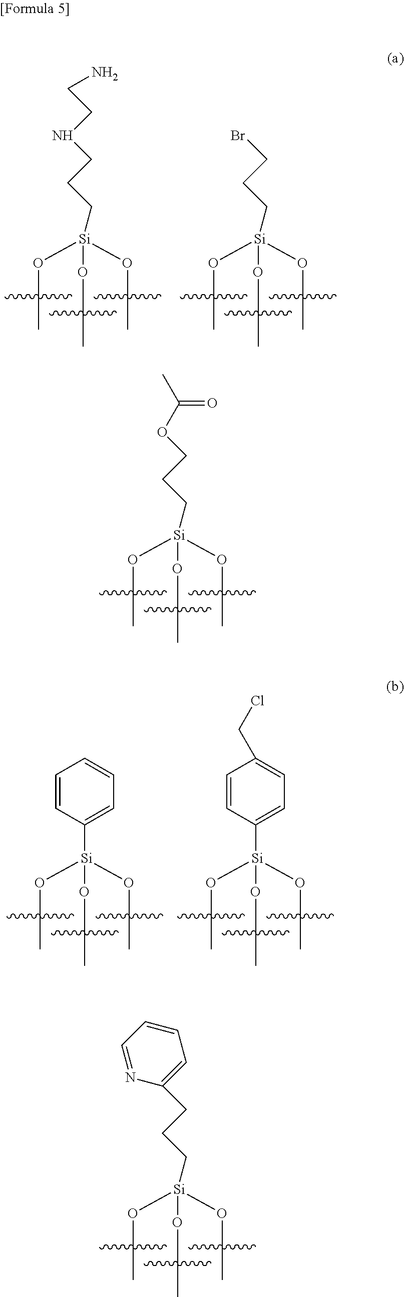 [SMILES: *O[Si](CCCNCCN)(O*)O* ; *O[Si](CCCBr)(O*)O* ; *O[Si](CCCOC(C)=O)(O*)O* ; *O[Si](O*)(O*)c1ccccc1 ; *O[Si](O*)(O*)c1ccc(CCl)cc1 ; *O[Si](CCCc1ccccn1)(O*)O*]

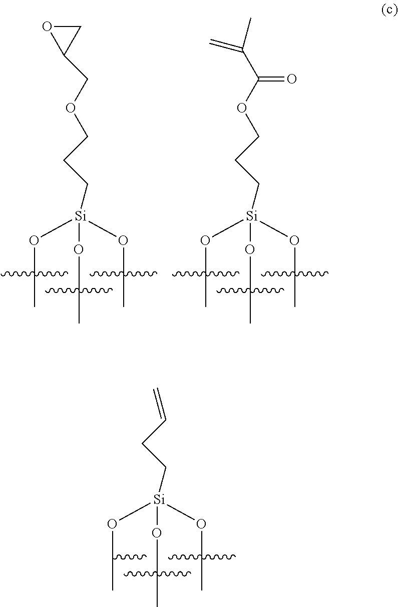

In the method for preparing a polymeric hollow fiber membrane having a crosslinked selective layer according to an embodiment of the present invention, the ladder-structured polysilsesquioxane has a second functional group capable of reacting with the first functional group. Here, the second functional group is not particularly limited as long as it can react with the first functional group described above.

In a specific embodiment of the present invention, the second functional group may be at least one selected from the group consisting of an amine group and an epoxy group. Preferably, the second functional group may be an amine group.

In a specific embodiment of the present invention, the first functional group may be a carboxyl group and the second functional group may be an amine group, or the first functional group may be an amine group and the second functional group may be an epoxy group.

In the method for preparing a polymeric hollow fiber membrane having a crosslinked selective layer according to an embodiment of the present invention, the polymer composition comprises 70 to 95% by weight of a glassy polymer having a first functional group and 5 to 30% by weight of a ladder-structured polysilsesquioxane having a second functional group capable of reacting with the first functional group. Preferably, in the preparation method according to an embodiment of the present invention, the polymer composition comprises 70 to 90% by weight or 75 to 90 by weight of a glassy polymer having a first functional group and 10 to 30% by weight or 10 to 25% by weight of a ladder-structured polysilsesquioxane having a second functional group capable of reacting with the first functional group. More preferably, in the preparation method according to an embodiment of the present invention, the polymer composition comprises 80 to 90% by weight of a glassy polymer having a first functional group and 10 to 20% by weight of a ladder-structured polysilsesquioxane having a second functional group capable of reacting with the first functional group. If the content ratio of the glassy polymer having a first functional group and the ladder-structured polysilsesquioxane having a second functional group capable of reacting with the first functional group in the polymer composition in the preparation method according to an embodiment of the present invention satisfies the above range, the crosslinked polymeric hollow fiber membrane support prepared therefrom has an excellent chemical resistance and thermal resistance. Therefore, as described below, even if a polyamic acid dissolved in an organic solvent is coated on the crosslinked polymeric hollow fiber membrane support, the structure of the crosslinked polymeric hollow fiber membrane support is not damaged.

In the method for preparing a polymeric hollow fiber membrane having a crosslinked selective layer according to an embodiment of the present invention, 70 to 100% of each of the first functional group and the second functional group may participate in the crosslinking reaction.

The crosslinked polymeric hollow fiber membrane support prepared in the method for preparing a polymeric hollow fiber membrane having a crosslinked selective layer according to an embodiment of the present invention has a crosslinked structure formed by reacting the first functional group and the second functional group.

In a specific embodiment of the present invention, the first functional group may be a carboxyl group, and the second functional group may be an amine group, so that the carboxyl group and the amine group are amidated to form a crosslinked structure in the method for preparing a polymeric hollow fiber membrane having a crosslinked selective layer according to an embodiment of the present invention.

Meanwhile, the organic solvent is not particularly limited as long as it dissolves the glassy polymer and the ladder-structured polysilsesquioxane and then is removed. Preferably, the organic solvent may be selected from the group consisting of N-methyl-2-pyrrolidone (NMP), dimethylformamide (DMF), tetrahydrofuran (THF), methylene chloride (MC), dimethyl sulfoxide (DMSO), and a mixture thereof.

The sequence of dissolving the glassy polymer and the ladder-structured polysilsesquioxane in an organic solvent is not particularly limited. Thus, the glassy polymer and the ladder-structured polysilsesquioxane may be mixed and then dissolved in an organic solvent. Alternatively, any one of the glassy polymer and the ladder-structured polysilsesquioxane may be first dissolved in an organic solvent and then the other one may be dissolved in the organic solvent.

The weight ratio of the organic solvent to the total weight of the glassy polymer and the ladder-structured polysilsesquioxane may be 0.1:99.9 to 40:60. Specifically, the weight of the solid contents of the glassy polymer and the ladder-structured polysilsesquioxane may be at least 0.1% by weight, at least 1% by weight, at least 5% by weight, at least 10% by weight, at least 15% by weight, at least 20% by weight, at least 25% by weight, at least 30% by weight, at least 35% by weight, or 40% by weight, and at most 40% by weight, at most 35% by weight, at most 30% by weight, at most 25% by weight, at most 20% by weight, at most 15% by weight, at most 10% by weight, at most 5% by weight, at most 1% by weight, or 0.1% by weight, based on the total weight of the glassy polymer, the ladder-structured polysilsesquioxane, and the organic solvent. More specifically, the weight of the solid contents of the glassy polymer and the ladder-structured polysilsesquioxane may be 0.1 to 40% by weight, 1 to 30% by weight, 5 to 20% by weight, or 7 to 13% by weight, based on the total weight of the glassy polymer, the ladder-structured polysilsesquioxane, and the organic solvent. If the total weight of the glassy polymer and the ladder-structured polysilsesquioxane is greater than 40% by weight of the glassy polymer, the ladder-structured polysilsesquioxane, and the organic solvent, it is difficult to form a polymeric hollow fiber membrane precursor. If it is less than 0.1% by weight, the gas separation performance may be impaired.

### Step (2)

In step (2), the polymer solution obtained in step (1) and a bore fluid are spun through a spinneret to form a polymeric hollow fiber membrane precursor.

The method for forming a polymeric hollow fiber membrane precursor from the polymer solution is not particularly limited. As a specific example, a dry-jet/wet-quench process may be used.

Here, the bore fluid spun with the polymer solution may be a mixture of an organic solvent and a non-solvent. The organic solvent in the bore fluid may be at least one selected from the group consisting of N-methyl-2-pyrrolidone (NMP) and dimethylformamide (DMF), but it is not limited thereto. The non-solvent in the bore fluid may be water, but it is not limited thereto. The weight ratio of the organic solvent to the non-solvent in the bore fluid may be in the range of 60:40 to 90:10, but it is not particularly limited to this range.

At the time of spinning, the temperature of the polymer solution and the bore fluid and the temperature of the pump and the line are preferably maintained at 50 to 70° C., but the temperature is not particularly limited thereto.

In addition, the flow rates of the polymer solution and the bore fluid are preferably maintained at 1.5 to 3.0 ml/min and 0.5 to 1.0 ml/min, respectively, but the flow rates are not particularly limited thereto.

It is preferable to use a cylindrical tip having a diameter of 200 to 300 μm as a spinning tip for the bore fluid and that having a diameter of 1,300 to 1,500 μm as a spinning tip for the polymer solution in the spinneret, but the sizes are not particularly limited thereto.

The highly volatile solvent is evaporated while the spun polymeric hollow fiber passes through the air gap, resulting in the formation of a dense film near the outer wall of the polymeric hollow fiber membrane. The height of the air gap may be, for example, 5 cm or more, 10 cm or more, or 20 cm or more, but the height is not particularly limited thereto. In general, a denser film can be formed near the outer wall of the polymeric hollow fiber membrane by the evaporation of the volatile solvent as the height of the air gap is increased to some extent. In order to coat a defect-free selective layer on the outer surface of a crosslinked polymeric hollow fiber membrane support, the pore size on the outer surface of the polymeric hollow fiber membrane precursor is appropriate to be about 10 to 30 nm, but it is not particularly limited thereto.

### Step (2′)

The method for preparing a polymeric hollow fiber membrane having a crosslinked selective layer according to an embodiment of the present invention may further comprise (2′) quenching the polymeric hollow fiber membrane precursor with a cooling medium.

In such an event, the cooling medium is preferably deionized water, but it is not particularly limited thereto. The temperature of the cooling medium is suitably from 25 to 50° C., but the temperature is not particularly limited thereto.

While the polymeric hollow fiber membrane precursor passes through the cooling medium, the phase transition takes place by the exchange of the cooling medium such as water with the organic solvent, thereby obtaining a polymeric hollow fiber membrane in a solid state.

### Step (2″)

The method for preparing a polymeric hollow fiber membrane having a crosslinked selective layer according to an embodiment of the present invention may further comprise (2″) winding the polymeric hollow fiber membrane precursor obtained in step (2′). For example, the polymeric hollow fiber membrane precursor in a solid state may be wound around a take-up drum. The winding speed is preferably 10 to 20 m/min, but the speed is not particularly limited thereto.

The take-up drum is partially immersed in deionized water contained in a container at room temperature. Thus, the polymeric hollow fiber membrane precursor may be immersed in deionized water for 10 to 20 minutes while it is wound around the take-up drum.

Subsequently, the polymeric hollow fiber membrane precursor may be cut to an appropriate length (for example, 20 to 50 cm) and immersed in separate deionized water for about 2 to 3 days to completely remove the solvent remaining in the polymeric hollow fiber membrane precursor. Thereafter, the polymeric hollow fiber membrane precursor, from which the solvent has been completely removed, is subjected to solvent exchange with a non-solvent in the order of a low surface tension such as methanol and hexane to remove remaining water. It is then exposed to air for one hour to remove hexane and dried in an oven.

### Step (3)

In step (3), the polymeric hollow fiber membrane precursor obtained in step (2) is thermally treated to form a crosslinked polymeric hollow fiber membrane support.

The conditions for the thermal treatment in step (3) are not particularly limited as long as the first functional group and the second functional group in the polymeric hollow fiber membrane precursor can react to form a crosslinked structure.

In a specific embodiment of the present invention, the thermal treatment may be carried out at a temperature of 300 to 400° C. Specifically, the thermal treatment temperature may be higher than 300° C. to lower than 400° C. More specifically, the thermal treatment temperature may be 320° C. to 380° C., and it may be carried out under isothermal conditions. If the thermal treatment temperature exceeds 400° C., the polymer may be carbonized. If it exceeds 500° C., steep mass variations may take place. Meanwhile, if the thermal treatment temperature is lower than 300° C., crosslinking may not take place sufficiently.

In a specific embodiment of the present invention, the thermal treatment may be carried out for 0.5 to 4 hours. Specifically, the thermal treatment time may be 0.5 to 3 hours, more specifically, 1 to 2 hours. If it is less than the above range, crosslinking may not take place sufficiently.

In a specific embodiment of the present invention, the thermal treatment may be carried out in an inert gas atmosphere. More specifically, the thermal treatment may be carried out in an argon gas atmosphere.

### Step (4)

In step (4), a polyimide precursor solution is coated on the surface of the crosslinked polymeric hollow fiber membrane support obtained in step (3).

The polyimide precursor coated on the surface of the crosslinked polymeric hollow fiber membrane support may be a polyamic acid prepared from an aromatic carboxylic dianhydride and an aromatic diamine described in step (1). Preferably, the aromatic carboxylic dianhydride may be benzophenone-3,3′,4,4′-tetracarboxylic dianhydride (BTDA), and the aromatic diamine may be a mixture of 2,3,5,6-tetramethylene-1,4-phenylenediamine (Durene) and 3,5-diaminobenzoic acid (DABA). Methods for preparing a polyamic acid from an aromatic carboxylic acid dianhydride and an aromatic diamine known in the technical field to which the present invention pertains may be used.

There is no particular limitation to the coating method as long as a polyimide precursor solution can be coated on the surface of the crosslinked polymeric hollow fiber membrane support. Specifically, dip-coating, spray coating, or the like may be used. Preferably, dip-coating may be used. Dip-coating methods known in the technical field to which the present invention pertains may be used.

### Step (5)

In step (5), the polymeric hollow fiber membrane support coated in step (4) is dried and then thermally condensed and thermally crosslinked.

The polymeric hollow fiber membrane support coated with a polyimide precursor solution in step (4) may be dried in the air at 20-30° C., preferably for 1 hour, and then dried in a vacuum oven set at 50-80° C., preferably 60° C., for 6 to 24 hours, preferably for 12 hours. Thereafter, it may be dried under vacuum at 100 to 180° C., preferably 120° C., for 12 to 48 hours, preferably for 24 hours, to remove the residual solvent.

After sufficient drying, the polyamic acid coated on the crosslinked polymeric hollow fiber membrane support is subjected to thermal condensation and thermal crosslinking to form a crosslinked selective layer of a polyimide polymer. Here, it is understood that thermal condensation is attributed to imidization, and thermal crosslinking is attributed to decarboxylation, but the present invention is not bound by this theory.

The conditions for the thermal condensation and thermal crosslinking in step (5) are not particularly limited as long as the polyamic acid can be imidized and thermally crosslinked. Specifically, the conditions for the thermal condensation and thermal crosslinking in step (5) are substantially the same as those for the thermal treatment in step (3).

In the method for preparing a polymeric hollow fiber membrane having a crosslinked selective layer according to an embodiment of the present invention, various polyimide precursors may be coated on the nanopore surface of a crosslinked polymeric hollow fiber membrane support and then subjected to a thermal condensation reaction to easily prepare polyimide hollow fiber membranes of various structures. In addition, it is possible to prepare a gas separation membrane with excellent separation performance by minimizing the thickness of the selective layer of a polymeric hollow fiber membrane prepared.

### Polymeric Hollow Fiber Membrane Having a Crosslinked Selective Layer

According to an embodiment of the present invention, there is provided a polymeric hollow fiber membrane having a crosslinked selective layer, which is prepared by the above method and comprises a crosslinked polymeric hollow fiber membrane support prepared from a polymer composition comprising 70 to 95% by weight of a glassy polymer having a first functional group and 5 to 30% by weight of a ladder-structured polysilsesquioxane having a second functional group capable of reacting with the first functional group and a selective layer formed on the support by thermal condensation and thermal crosslinking of a polyimide precursor solution.

The polymeric hollow fiber membrane having a crosslinked selective layer prepared by the preparation method according to an embodiment of the present invention comprises a support and a selective layer. Here, the support is prepared from a polymer composition comprising 70 to 95% by weight of a glassy polymer having a first functional group and 5 to 30% by weight of a ladder-structured polysilsesquioxane having a second functional group capable of reacting with the first functional group, and the selective layer is formed on the support by thermal condensation and thermal crosslinking of a polyimide precursor solution.

As the polymeric hollow fiber membrane having a crosslinked selective layer according to an embodiment of the present invention comprises a support having a crosslinked structure and the selective layer having a thin thickness, it may be enhanced in plasticization resistance, chemical resistance, and durability.

In general, a polymer membrane does not contain micropores in the selective layer. But the thermal fluctuation of the polymer chains creates empty spaces, i.e., free volume, between the chains, through which a gas permeates. Conventional polymer membranes, however, involve the aging phenomenon that decreases the permeability over time and the plasticization phenomenon that reduces the selectivity to condensable gases under high pressures.

In contrast, in the polymeric hollow fiber membrane having a crosslinked selective layer according to an embodiment of the present invention, the selective layer formed on the surface of the support by thermal condensation and thermal crosslinking of a polyimide precursor solution is thin and has a crosslinked structure, thereby exhibiting excellent separation performance and plasticization resistance.

The polymeric hollow fiber membrane according to an embodiment of the present invention may have an outer diameter of 200 to 400 μm and an inner diameter of 100 to 200 μm. Preferably, the polymeric hollow fiber membrane may have an outer diameter of 250 to 350 μm and an inner diameter of 120 to 180 μm.

In the polymeric hollow fiber membrane having a crosslinked selective layer according to an embodiment of the present invention, the selective layer may have a thickness of 100 nm to 3 μm. Preferably, the thickness of the selective layer in the polymeric hollow fiber membrane may be 100 nm to 1.5 μm.

The polymeric hollow fiber membrane having a thin crosslinked selective layer according to an embodiment of the present invention can be effectively used in the separation of a mixed gas.

In addition, the polymeric hollow fiber membrane having a thin crosslinked selective layer according to an embodiment of the present invention may be used as a precursor for a carbon molecular sieve hollow fiber membrane.

### Method for Preparing a Carbon Molecular Sieve Hollow Fiber Membrane

According to an embodiment of the present invention, there is provided a method for preparing a carbon molecular sieve hollow fiber membrane having a crosslinked selective layer, which comprises (1) dissolving a polymer composition comprising 70 to 95% by weight of a glassy polymer having a first functional group and 5 to 30% by weight of a ladder-structured polysilsesquioxane having a second functional group capable of reacting with the first functional group in an organic solvent to prepare a polymer solution; (2) spinning the polymer solution obtained in step (1) and a bore fluid through a spinneret to form a polymeric hollow fiber membrane precursor; (3) thermally treating the polymeric hollow fiber membrane precursor obtained in step (2) to form a crosslinked polymeric hollow fiber membrane support; (4) coating a polyimide precursor solution on the surface of the crosslinked polymeric hollow fiber membrane support obtained in step (3); (5) drying the polymeric hollow fiber membrane support coated in step (4) and thermally condensing and thermally crosslinking it to obtain a polymeric hollow fiber membrane having a crosslinked selective layer; and (6) pyrolyzing the polymeric hollow fiber membrane having a crosslinked selective layer obtained in step (5).

The above steps (1) to (5) are substantially the same as the steps (1) to (5) described in the method for preparing a polymeric hollow fiber membrane having a crosslinked selective layer.

### Step (6)

In step (6), the polymeric hollow fiber membrane having a crosslinked selective layer obtained in step (5) is pyrolyzed (i.e., carbonized).

The apparatus for pyrolysis (i.e., carbonization) of the polymeric hollow fiber membrane having a crosslinked selective layer is not particularly limited. Specifically, a polymeric hollow fiber membrane having a crosslinked selective layer is placed on a quartz plate in a quartz tube of a pyrolysis apparatus. Then, the temperature is raised to a level at which pyrolysis can be carried out while an inert gas such as argon is continuously fed thereto. Preferably, for the pyrolysis, the temperature is raised from room temperature to 250° C. at a rate of 10° C./min, from 250° C. to T_{soaking} (i.e., final carbonization temperature)−15° C. at a rate of 3.85° C./min, and from T_{soaking}−15° C. to T_{soaking} at a rate of 0.25° C./min. The temperature is then maintained for 2 hours at the carbonization temperature (T_{soaking}). But the pyrolysis conditions are not particularly limited thereto. The final pyrolysis temperature of the polymeric hollow fiber membrane having a crosslinked selective layer in the present invention is suitably 500 to 900° C. It is preferable to maintain the final pyrolysis temperature for 1 to 2 hours.

### Carbon Molecular Sieve Hollow Fiber Membrane

According to an embodiment of the present invention, there is provided a carbon molecular sieve hollow fiber membrane, which comprises a carbonized product of a polymeric hollow fiber membrane having a crosslinked selective layer, which is prepared by the above method and comprises a crosslinked polymeric hollow fiber membrane support prepared from a polymer composition comprising 70 to 95% by weight of a glassy polymer having a first functional group and 5 to 30% by weight of a ladder-structured polysilsesquioxane having a second functional group capable of reacting with the first functional group and a selective layer formed on the support by thermal condensation and thermal crosslinking of a polyimide precursor solution.

The carbon molecular sieve hollow fiber membrane according to an embodiment of the present invention may have an outer diameter of 100 to 300 μm and an inner diameter of 75 to 150 μm. Preferably, the carbon molecular sieve hollow fiber membrane may have an outer diameter of 150 to 250 μm and an inner diameter of 80 to 130 μm.

The carbon molecular sieve hollow fiber membrane according to an embodiment of the present invention has a crosslinked selective layer, wherein the selective layer may have a thickness of 100 nm to 3 μm. Preferably, the thickness of the selective layer in the carbon molecular sieve hollow fiber membrane may be 100 nm to 1.5 μm.

The polymeric hollow fiber membrane having a thin crosslinked selective layer according to an embodiment of the present invention can be effectively used in the separation of a mixed gas.

### Gas Separation Method

According to an embodiment of the present invention, there is provided a method for separating gases, which comprises passing a mixed gas containing at least two types of gases through the polymeric hollow fiber membrane or the carbon molecular sieve hollow fiber membrane, each of which has a crosslinked selective layer according to an embodiment of the present invention to remove at least a portion of at least one type of the gases.

In a specific embodiment of the present invention, the method may comprise separating at least a portion of at least one type of gas from a mixed gas containing at least two types of gases. For example, the method may comprise separating at least a portion of at least one type of gas from a mixed gas comprising a combination selected from carbon dioxide/nitrogen, carbon dioxide/carbon tetrachloride, carbon dioxide/methane, hydrogen/nitrogen, hydrogen/carbon dioxide, hydrogen/methane, oxygen/nitrogen, and the like. But it is not particularly limited thereto.

### EXAMPLE

Hereinafter, the present invention will be described in more detail with reference to Examples and Comparative Examples. However, the following examples are for illustrative purposes only and are not intended to limit the scope of the present invention.

### Preparation Example 1: Preparation of a Crosslinked Polymeric Hollow Fiber Membrane Support

### Preparation of a Polyimide

88 ml of N-methyl-2-pyrrolidone (NMP) was added to 6.54 g of benzophenone-3,3′,4,4′-tetracarboxylic dianhydride (BTDA) and 3.24 g of a mixture of 2,3,5,6-tetramethyl-1,4-phenylenediamine (Durene) and 3,5-diaminobenzoic acid (DABA) (molar ratio 3:2) to prepare a monomer solution of 10% by weight. The solution was stirred at about 5° C. for 24 hours to obtain a high-molecular-weight polyamic acid solution. 1.95 g of P-picoline and 19.5 g of acetic anhydride were added to the polyamic acid solution, which was stirred at room temperature for 24 hours for imidization. The precipitated polyimide (BTDA-Durene:DABA (3:2)) was washed with methanol and dried at 180° C. under vacuum for 24 hours to obtain 8.90 g (yield: 91%) of BTDA-Durene:DABA (3:2) (hereinafter abbreviated as “PI-3:2”).

### Preparation of a Polysilsesquioxane

A 100-ml round bottom flask was charged with 0.04 g of potassium carbonate, 4.8 g of deionized water, and 8 g of tetrahydrofuran (THF) to obtain a clear solution. 9.52 g of phenyltrimethoxysilane and 10.68 g of [3-(2-aminoethylamino)propyl]trimethoxysilane were added dropwise thereto under nitrogen. The reaction mixture was vigorously stirred for 5 days. After evaporation of the volatile materials, the white resinous portion was dissolved in 100 ml of dichloromethane and extracted several times with water. The organic material was collected, dried over anhydrous magnesium sulfate, and filtered. Dichloromethane was evaporated to obtain 16.2 g of a white powder of poly(phenyl-co-3-(2-aminoethylamino)propyl)silsesquioxane (LPDA64) (yield: 80%).

### Preparation of a Polymer Solution

The polyimide (BTDA-Durene:DABA (3:2)) and polysilsesquioxane (LPDA64) prepared above were mixed at a weight ratio of 90:10. This polymer mixture was dissolved in a mixed organic solvent of N-methyl-2-pyrrolidone (NMP), tetrahydrofuran (THF), and ethanol. A mixture of N-methyl-2-pyrrolidone (NMP) and water was separately prepared as a bore fluid. The content of each component constituting the polymer solution is as shown in Table 1 below. In addition, the composition of the bore fluid is shown in Table 2 below.

TABLE 1

| Composition of the polymer solution | Part by weight |
|---|---|
| BTDA-Durene:DABA (3:2) | 24.3 |
| LPDA64 | 2.7 |
| NMP | 54.4 |
| THF | 8.1 |
| Ethanol | 10.5 |
| Total | 100.0 |

TABLE 2

| Composition of bore fluid | Part by weight |
|---|---|
| NMP | 80.0 |
| Water | 20.0 |
| Total | 100.0 |

### Preparation of a Polymeric Hollow Fiber Membrane Precursor

The polymer solution of Table 1 and the bore fluid of Table 2 were spun using the dry-jet/wet-quench process to prepare a polymeric hollow fiber membrane precursor. The spinning conditions were shown in Table 3 below. The polymeric hollow fiber membrane precursor thus fabricated had an outer diameter and an inner diameter of 320 μm and 170 μm, respectively.

TABLE 3

| | |
|---|---|
| Flow rate of the polymer solution (ml/min) | 2 |
| Flow rate of the bore fluid (ml/min) | 1 |
| Air gap (cm) | 13 |
| Pump temp. (° C.) | 50 |
| Line temp. (° C.) | 50 |
| Spinneret temp. (° C.) | 50 |
| Cooling medium temp. (° C.) | 40 |
| Winding speed (m/min) | 100 |

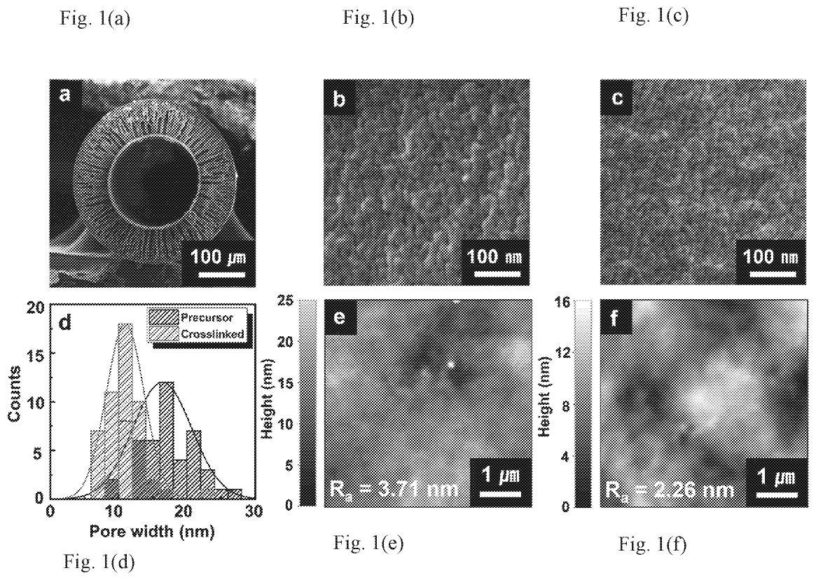

The polymeric hollow fiber membrane precursor was removed from the take-up drum, cut to a length of about 30 cm, and immersed in deionized water for 3 days. In such an event, the deionized water was replaced every day. Thereafter, the polymeric hollow fiber membrane precursor was washed with methanol for 30 minutes three times and with hexane three times. Then, the polymeric hollow fiber membrane precursor was dried in the air at room temperature for one hour and dried at 75° C. under vacuum for 12 hours. The outer and inner diameters of the polymer hollow fiber membrane precursor were confirmed to be 320 μm and 170 μm, respectively, by scanning electron microscopy (SEM) (FIG. 1a).

### Thermal Treatment of the Polymeric Hollow Fiber Membrane Precursor

The polymeric hollow fiber membrane precursor obtained above was placed on the quartz plate (United Silica Products, USA) in the quartz tube (MTI, USA) of a thermal treatment apparatus, and both ends of the quartz tube were sealed with metal flanges having a silicon O-ring. To control the inside temperature of the quartz tube in the thermal treatment apparatus accurately and uniformly, a three-zone furnace (Thermcraft, USA) was used. Thermal treatment was carried out while argon was continuously fed into the quartz tube at a rate of 400 cm³/minute. In such an event, the temperature and the temperature elevation rate were as shown in Table 4 below.

TABLE 4

| Initial temp. | Final temp. | Temp. elevation rate |
|---|---|---|
| (° C.) | (° C.) | (° C./min) |
| 50 | 320 | 10 |
| 320 | 370 | 1 |
| 370 | 370 | Maintained for 1 hour |

The surface of the thermally treated polymeric hollow fiber membrane support was observed using SEM to confirm that the average pore size of the surface decreased from 18 nm to 12 nm (FIGS. 1b-d). In addition, atomic force microscopy (AFM) analysis showed that the surface roughness (Ra) decreased from 3.71 nm to 2.26 nm (FIGS. 1e-f). The decrease in pore size and roughness is understood to be attributed to the relaxation of polymer chains after the thermal treatment at a temperature above the glass transition temperature (Tg).

### Preparation Example 2: Preparation of a Polymeric Hollow Fiber Membrane Having a Crosslinked Selective Layer

### Coating and Thermal Condensation and Thermal Crosslinking of a Crosslinked Polymeric Hollow Fiber Membrane

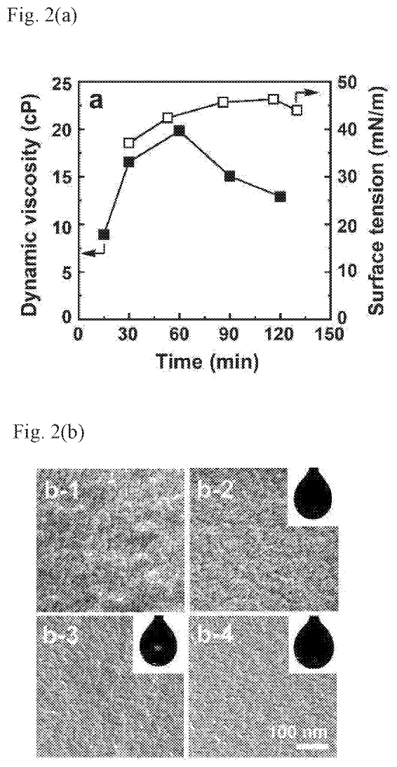

A monomer mixture of BTDA (1.1922 g), Durene (0.3648 g), and DABA (0.2244 g) was completely dissolved in 12.96 g of NMP and 3.24 g of dichloromethane, which was then stirred at room temperature for 30 minutes to 2 hours. In order to observe the change in molecular weight of the polyamic acid solution of BTDA-Durene:DABA (3:2) with respect to reaction time, the viscosity was measured. The viscosity increased to 19.8 cp until 60 minutes from the start of the reaction due to the polymerization reaction, but the viscosity decreased until 120 minutes thereafter due to a depolymerization reaction (FIG. 2a). In addition, the surface tension increased as the reaction time increased (FIG. 2a).

The polyamic acid obtained above was coated on the surface of the crosslinked polymeric hollow fiber membrane support obtained in Preparation Example 1 using a dip-coater. Here, the immersion rate and withdrawing rate of the crosslinked polymeric hollow fiber membrane (support) were each 0.5 cm/s, and the immersion time was 60 seconds.

The coated hollow fiber membrane (support) was dried in the air for 1 hour and then dried in a vacuum oven set at 60° C. for 12 hours. Thereafter, it was dried at 120° C. under vacuum for 24 hours to remove the residual solvent. Subsequently, thermal treatment (thermal condensation) was carried out under the temperature raising conditions in Table 4 using the thermal treatment apparatus of Preparation Example 1.

The surface of the crosslinked polymeric hollow fiber membrane and the surface of the crosslinked polymeric hollow fiber membrane after coating with respect to the reaction time of the polyamic acid solution of BTDA-Durene:DABA (3:2) were observed to confirm that the surface roughness of the polymeric hollow fiber membrane decreased as the reaction time increased (FIG. 2b). When a crosslinked polymeric hollow fiber membrane support was coated with a polyamic acid solution, the surface tension of the polymer solution increased with reaction time, the excellent wettability of the support increased the capillary force, which allowed effective coating of the pores of the crosslinked polymeric hollow fiber membrane support.

For comparison, 1.8 g of a polyimide of BTDA-Durene:DABA (3:2), instead of the polyamic acid of BTDA-Durene:DABA (3:2), was dissolved in 12.96 g of NMP and 3.24 g of dichloromethane and stirred for 24 hours, which was coated on a crosslinked polymeric hollow fiber membrane support. Here, the conditions for coating of the polyimide solution and for drying and thermal treatment of the crosslinked polymeric hollow fiber membrane support after coating are the same as those for coating of the polyamic solution and for drying and thermal treatment of the crosslinked polymeric hollow fiber membrane support after coating.

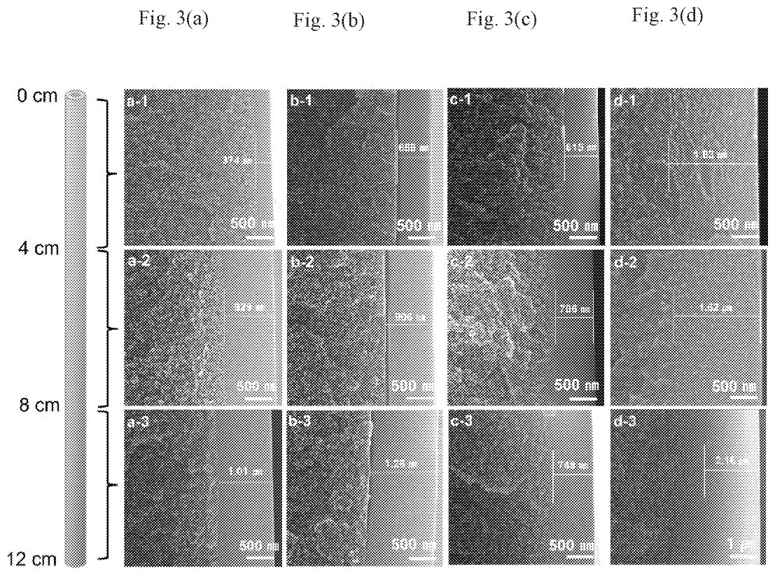

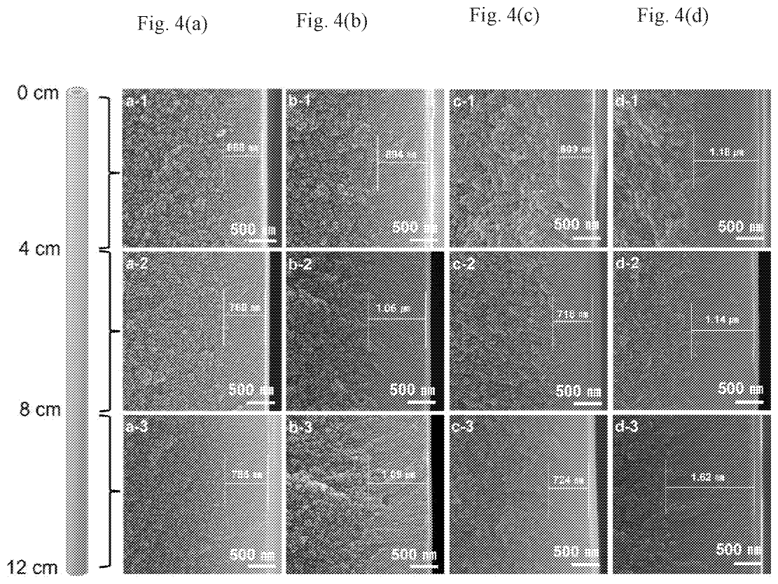

SEM images showed that a selective layer of BTDA-Durene:DABA (3:2) polyimide was formed on the surface of the crosslinked polymeric hollow fiber membrane support by dip-coating and thermal condensation (FIGS. 3 and 4). To measure the thickness of the selective layer with respect to the axial position within the hollow fiber membrane, a hollow fiber membrane with a length of 12 cm was divided into three parts and SEM images for cross-sections were taken. For the hollow fiber membrane coated with a polyamic acid solution, a thin selective layer with a thickness of 374 nm to 1.26 μm was formed. In addition, the thickness of the selective layer increased as the height within the hollow fiber membrane decreased due to gravity during dip-coating. In particular, for the polyamic acid solution reacted for 60 minutes, the thickest selective layer was formed due to its high viscosity. For the hollow fiber membrane coated with a polyimide polymer solution, a selective layer with a thickness of 1.63-2.16 μm was formed due to its high viscosity (66 cp). The same trend was shown even after thermal treatment at 370° C. (FIG. 4).

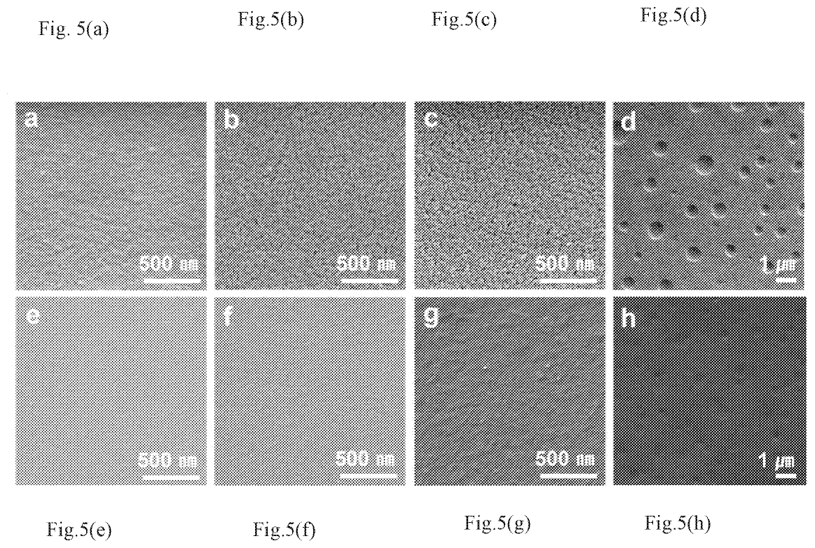

The surface of the hollow fiber membrane after dip-coating and thermal condensation was observed to confirm that the hollow fiber membrane support coated with a polyamic acid solution had no defects on the surface (FIG. 5). In contrast, for the hollow fiber membrane support coated with a polyimide polymer solution, circular dimples were formed on the surface (FIG. 5). This is understood to be caused by rapid evaporation of the solvent from the polymeric hollow fiber membrane support.

The gas permeability of the polymeric membrane having a crosslinked selective layer prepared above was measured at 2 bar and 35° C. (Table 5). The polymeric hollow fiber membrane coated with a polyamic acid solution of BTDA-Durene:DABA (3:2) reacted for 60 minutes showed the highest permeability of H₂ and CO₂. In addition, as the reaction time of a polyamic acid increased, the surface tension of the solution increased and the capillary force increased. As a result, the pores of the crosslinked polymeric hollow fiber membrane support were effectively coated, showing high selectivity of H₂/N₂, CO₂/CH₄, and O₂/N₂. In addition, it is understood that thermal crosslinking through decarboxylation also contributed to achieving excellent separation performance. The polymeric hollow fiber membrane coated with a polyimide polymer solution showed the lowest permeability of H₂ and CO₂ due to the thick selective layer (1.4 μm).

The gas permeability and selectivity of the polymeric hollow fiber membrane having a crosslinked selective layer according to the present invention are equal to, or better than, those of a flat membrane made of BTDA-Durene:DABA (3:2) with a thickness of 25 μm and then thermally treated at 370° C. In particular, the gas permeability and selectivity of the polymeric hollow fiber membrane having a crosslinked selective layer according to the present invention were far better than those of the hollow fiber membrane coated with a polyimide solution and thermally treated at 370° C.

TABLE 5

| | | | | | | Selectivity (−) | | |
|---|---|---|---|---|---|---|---|---|
| Reaction | Permeability (GPU) | | | | | H₂/ | CO₂/ | O₂/ |
| time (min) | H₂ | CO₂ | O₂ | N₂ | CH₄ | N₂ | CH₄ | N₂ |
| Flat | 43 | 16 | 4.1 | 0.55 | 0.37 | 78 | 43 | 7.5 |
| membrane¹ | | | | | | | | |
| 30 | 69 | 20 | 5.1 | 0.95 | 0.67 | 73 | 30 | 5.4 |
| 60 | 80 | 20 | 5.0 | 0.69 | 0.45 | 116 | 46 | 7.2 |
| 120 | 56 | 15 | 3.7 | 0.53 | 0.33 | 104 | 46 | 6.9 |
| PI | 33 | 9.5 | 2.2 | 0.37 | 0.25 | 89 | 38 | 5.9 |
| solution | | | | | | | | |

¹Unit of permeability: Barrer

Changes in the Thickness of a Selective Layer with Respect to the Polymerization Conditions of a Polyamic Acid

To evaluate changes in the separation performance of a polymeric hollow fiber membrane with respect to the polymerization conditions of a polyamic acid (specifically, polymerization temperature), a polyamic acid was polymerized at 0° C. under a nitrogen purge. Specifically, a monomer mixture of BTDA (1.1922 g), Durene (0.3648 g), and DABA (0.2244 g) was completely dissolved in 12.96 g of NMP and 3.24 g of dichloromethane, which was then stirred for 60 minutes at 0° C. under a nitrogen purge.

The polyamic acid solution obtained above was coated on the surface of the crosslinked polymeric hollow fiber membrane support using a dip-coater. Here, the immersion rate and withdrawing rate of the crosslinked polymeric hollow fiber membrane support were each 0.5 cm/s, and the immersion time was 60 seconds.

The coated polymeric hollow fiber membrane support was dried in the air for 1 hour and then dried in a vacuum oven set at 60° C. for 12 hours. Thereafter, it was dried at 120° C. under vacuum for 24 hours to remove the residual solvent. Subsequently, thermal treatment (thermal condensation and thermal crosslinking) was carried out under the temperature raising conditions in Table 4 using the thermal treatment apparatus of Preparation Example 1.

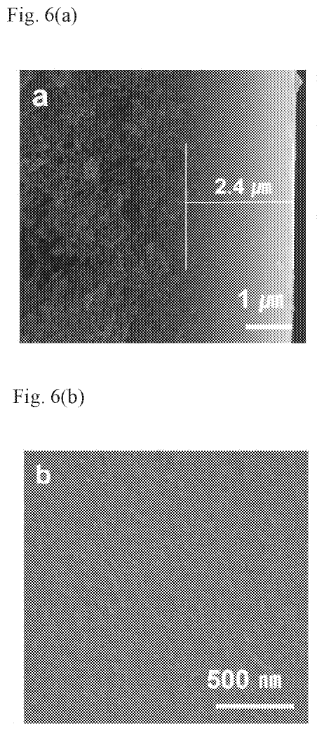

The cross-section and surface of the polymeric hollow fiber membrane having a crosslinked selective layer after thermal treatment were observed (FIG. 6). In the polymeric hollow fiber membrane having a crosslinked selective layer, the thickness of the selective layer was about 2.4 μm, indicating that the thickness of the selective layer was significantly thicker than that of the polymeric hollow fiber membrane in which the polyamic acid was reacted at room temperature. It is understood that the solution containing a polyamic acid polymerized at a low temperature under a nitrogen atmosphere had a high viscosity due to its high molecular weight as compared with the polyamic acid solution polymerized at room temperature.

Evaluation of the Separation Performance of a Polymer Hollow Fiber Membrane Having a Crosslinked Selective Layer with Respect to Dip-Coating Conditions

A monomer mixture of BTDA (1.1922 g), Durene (0.3648 g), and DABA (0.2244 g) was completely dissolved in 12.96 g of NMP and 3.24 g of dichloromethane, which was then stirred at room temperature for 60 minutes.

The polyamic acid solution obtained above was coated on the surface of the crosslinked polymeric hollow fiber membrane support using a dip-coater. Here, the immersion rate of the crosslinked polymeric hollow fiber membrane support was 0.5 cm/s, the immersion time was 60 seconds, and the withdrawing rate was 0.83 mm/s to 5 mm/s.

The crosslinked polymeric hollow fiber membrane support thus coated was dried in the air for 1 hour and then dried in a vacuum oven set at 60° C. for 12 hours. Thereafter, it was dried at 120° C. under vacuum for 24 hours to remove the residual solvent. Subsequently, thermal treatment (thermal condensation) was carried out under the temperature raising conditions in Table 4 using the thermal treatment apparatus of Preparation Example 1.

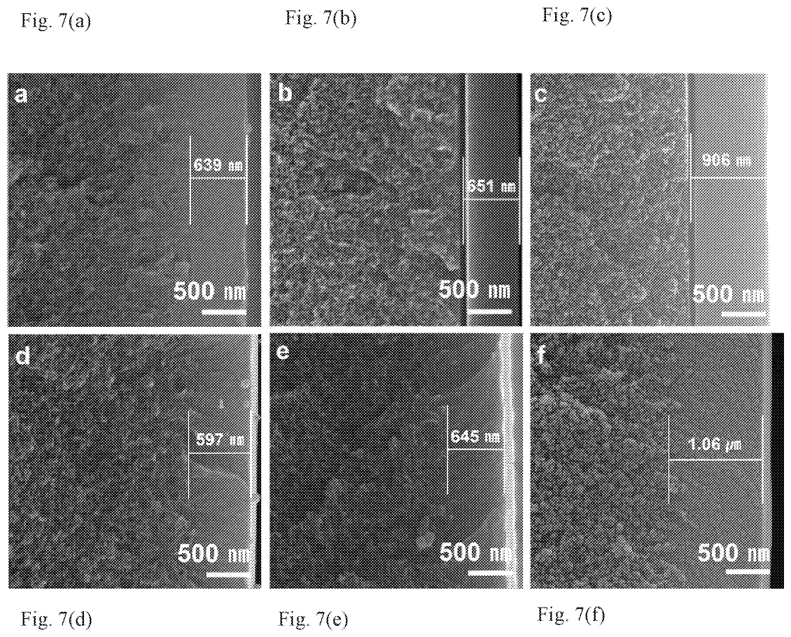

As a result, as the withdrawing rate decreased, the thickness of the selective layer decreased to 597 nm (FIG. 7). In addition, as the withdrawing rate decreased, the permeability of H₂ and CO₂ decreased (based on 2 bar, 35° C.) (Table 6).

TABLE 6

| | Immer- | | | | | | | | |
|---|---|---|---|---|---|---|---|---|---|
| Withdrawing | sion | | | | | | Selectivity (−) | | |
| rate | time | Permeability (GPU) | | | | | H₂/ | CO₂/ | O₂/ |
| (mm/s) | (min) | H₂ | CO₂ | O₂ | N₂ | CH₄ | N₂ | CH₄ | N₂ |
| Flat | — | 43 | 16 | 4.1 | 0.55 | 0.37 | 78 | 43 | 7.5 |
| membrane¹ | | | | | | | | | |
| 0.83 | 1 | 47 | 14 | 3.3 | 0.57 | 0.50 | 82 | 27 | 5.7 |
| 5.0 | 1 | 80 | 20 | 5.0 | 0.69 | 0.45 | 116 | 46 | 7.2 |

¹Unit of permeability: Barrer

To evaluate the depth at which the polymer solution penetrated into the crosslinked polymeric hollow fiber membrane support with respect to the withdrawing rate and immersion time, a polymeric hollow fiber membrane having a selective layer of 6FDA-Durene:DABA (3:2) was prepared.

Specifically, a monomer mixture of 6FDA (1.325 g), Durene (0.2939 g), and DABA (0.1825 g) was completely dissolved in 12.96 g of NMP and 3.24 g of dichloromethane, which was then stirred at room temperature for 60 minutes.

The polyamic acid solution obtained above was coated on the surface of the crosslinked polymeric hollow fiber membrane support using a dip-coater. Here, the immersion rate of the crosslinked polymeric hollow fiber membrane support was 0.5 cm/s.

The crosslinked hollow fiber membrane support thus coated was dried in the air for 1 hour and then dried in a vacuum oven set at 60° C. for 12 hours. Thereafter, it was dried at 120° C. under vacuum for 24 hours to remove the residual solvent. Subsequently, thermal treatment (thermal condensation and thermal crosslinking) was carried out under the temperature raising conditions in Table 4 using the thermal treatment apparatus of Preparation Example 1.

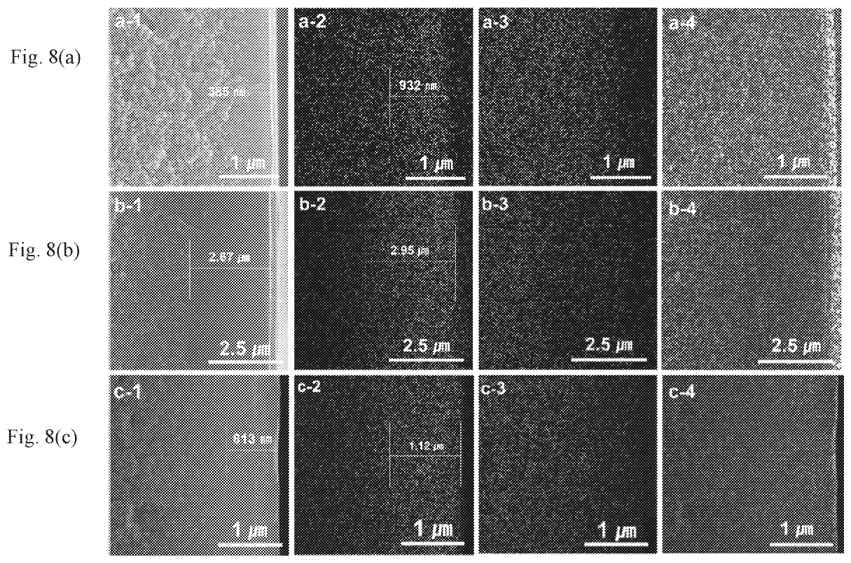

The cross-section of the polymeric hollow fiber membrane having a crosslinked selective layer based on 6FDA-Durene:DABA (3:2) was observed to confirm that the actual selective layer thickness due to penetration was significantly thicker than the apparent selective layer thickness of the coated polymer (FIG. 8).

Meanwhile, when the immersion time was increased to 3 minutes at the same withdrawing rate, the selective layer thickness was increased from 1.12 μm to 2.95 μm due to the penetration of the solution into the hollow fiber membrane (support). Thus, it is understood that as the withdrawing rate decreases, the time for which the crosslinked polymeric hollow fiber membrane support is exposed to the solvent increases, allowing the solution to penetrate into the support and decrease the permeability.

### Preparation of a Polymeric Hollow Fiber Membrane Having a Crosslinked Selective Layer Formed by Coating a 6FDA-Based Polyamic Acid Solution

A monomer mixture of 6FDA (1.325 g), Durene (0.2939 g), and DABA (0.1825 g) was completely dissolved in 12.96 g of NMP and 3.24 g of dichloromethane, which was then stirred at room temperature for 10 minutes to 2 hours.

The polyamic acid solution obtained above was coated on the surface of the crosslinked polymeric hollow fiber membrane support using a dip-coater. Here, the immersion rate and withdrawing rate of the crosslinked polymeric hollow fiber membrane support were each 0.5 cm/s, and the immersion time was 60 seconds.

The crosslinked polymeric hollow fiber membrane support thus coated was dried in the air for 1 hour and then dried in a vacuum oven set at 60° C. for 12 hours. Thereafter, it was dried at 120° C. under vacuum for 24 hours to remove the residual solvent. Subsequently, thermal treatment (thermal condensation and thermal crosslinking) was carried out under the temperature raising conditions in Table 4 using the thermal treatment apparatus of Preparation Example 1.

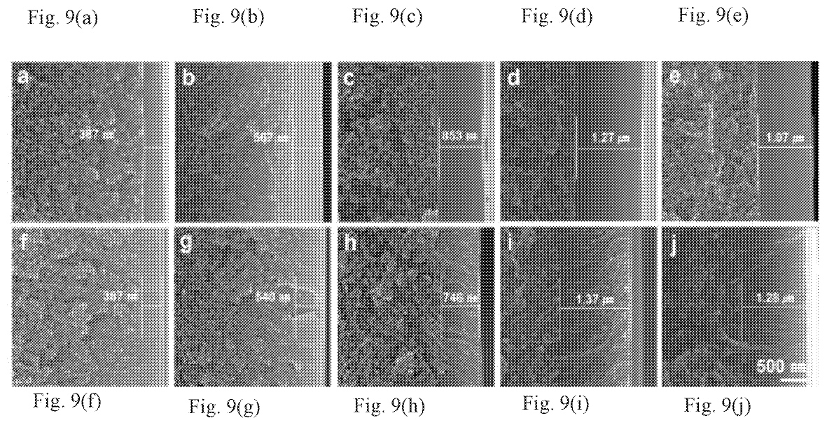

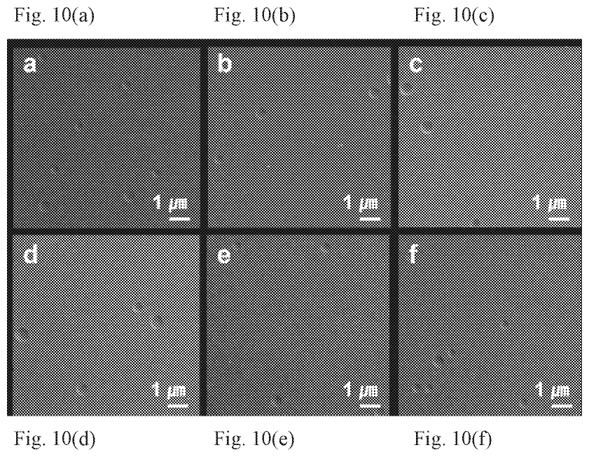

The thermally treated polymeric hollow fiber membranes with a coating of 6FDA-Durene:DABA (3:2) were confirmed to have a selective layer thickness between 387 nm and 1.37 μm. As the reaction time of the polyamic acid increased from 10 to 60 minutes, the thickness of the selective layer increased (FIG. 9). The surface of the polymeric hollow fiber membrane was observed using SEM to confirm that circular dimples were formed due to dewetting (FIG. 10). They are understood to be formed by undesirable interactions between the support and the 6FDA-Durene:DABA (3:2) polyimide.

The gas permeability of the polymeric membrane prepared above was measured at 2 bar and 35° C. (Table 7).

TABLE 7

| Reaction | | | | | | Selectivity (−) | | |
|---|---|---|---|---|---|---|---|---|
| time | Permeability (GPU) | | | | | H₂/ | CO₂/ | O₂/ |
| (min) | H₂ | CO₂ | O₂ | N₂ | CH₄ | N₂ | CH₄ | N₂ |
| 20 | 140 | 65 | 15.8 | 3.1 | 2.1 | 45 | 31 | 5.1 |
| 30 | 177 | 85 | 14 | 4.1 | 3.0 | 43 | 29 | 3.4 |
| 60 | 175 | 88 | 17 | 3.5 | 2.2 | 49 | 40 | 4.9 |

### Preparation Example 3: Preparation of a Carbon Molecular Sieve Hollow Fiber Membrane

The polymeric hollow fiber membrane having a crosslinked selective layer formed by coating a 6FDA-based polyamic acid solution was carbonized using the thermal treatment apparatus of Preparation Example 1 under the temperature increase conditions in Table 8.

TABLE 8

| Initial temp. | Final temp. | Temp. elevation rate |
|---|---|---|
| (° C.) | (° C.) | (° C./min) |
| 50 | 250 | 10 |
| 250 | 535 | 3.85 |
| 535 | 550 | 0.25 |
| 550 | 550 | Maintained for 2 hours |

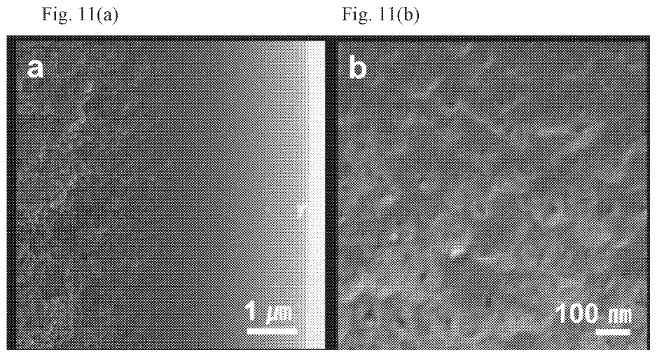

The carbon molecular sieve hollow fiber membrane with a coating of 6FDA-Durene:DABA (3:2) prepared by carbonizing a polymeric hollow fiber membrane having a crosslinked selective layer formed by coating a polyamic acid solution reacted for 60 minutes was confirmed to have a selective layer thickness of 2.83 μm (FIG. 11).

The gas permeability of the carbon molecular sieve hollow fiber membrane prepared above was measured at 1 bar and 35° C. (Table 9).

TABLE 9

| polyamic acid | | | | | | Selectivity (−) | | |
|---|---|---|---|---|---|---|---|---|
| reaction time | Permeability (GPU) | | | | | H₂/ | CO₂/ | O₂/ |
| (min) | H₂ | CO₂ | O₂ | N₂ | CH₄ | N₂ | CH₄ | N₂ |
| 60 | 697 | 271 | 50 | 7.2 | 4.6 | 97 | 59 | 6.9 |

What is claimed is:

1. A polymeric hollow fiber membrane, which comprises:
a crosslinked polymeric hollow fiber membrane support prepared from a polymer composition comprising 70 to 95% by weight of a glassy polymer having a first functional group and 5 to 30% by weight of a ladder-structured polysilsesquioxane having a second functional group capable of reacting with the first functional group; and
a crosslinked selective layer formed on the crosslinked polymeric hollow fiber support,
wherein polymeric hollow fiber membrane is prepared by a method comprising:
(1) dissolving the polymer composition in an organic solvent to prepare a polymer solution; (2) spinning the polymer solution obtained in step (1) and a bore fluid through a spinneret to form a polymeric hollow fiber membrane precursor; (3) thermally treating the polymeric hollow fiber membrane precursor obtained in step (2) to form the crosslinked polymeric hollow fiber membrane support; (4) coating a polyimide precursor solution on the surface of the crosslinked polymeric hollow fiber membrane support obtained in step (3); and (5) drying the polymeric hollow fiber membrane support coated in step (4) and thermally condensing and thermally crosslinking it.

2. The polymeric hollow fiber membrane of claim 1, wherein the glassy polymer is a polyimide obtained by polycondensation of an aromatic carboxylic dianhydride and an aromatic diamine.

3. The polymeric hollow fiber membrane of claim 2, wherein the aromatic carboxylic dianhydride is at least one selected from the group consisting of 4,4′-hexafluoroisopropylidene)diphthalic anhydride (6FDA) having a structure of Formula 1(a) below, benzophenone-3,3′,4,4′-tetracarboxylic dianhydride (BTDA) having a structure of Formula 1(b) below, 4′4-oxydiphthalic dianhydride (ODPA) having a structure of Formula 1(c) below, pyromellitic dianhydride having a structure of Formula 1(d) below, 3,3′4,4′-biphenyltetracarboxylic dianhydride (BPDA) having a structure of Formula 1(e) below, 3,3′,4,4′-diphenylsulfonetetracarboxylic dianhydride having a structure of Formula 1(f) below, 3,4′-oxydiphthalic anhydride having a structure of Formula 1(g) below, dibromopyromellitic dianhydride having a structure of Formula 1(h) below, and naphthalene-1,4,5,8-tetracarboxylic dianhydride having a structure of Formula 1(i) below; and
wherein the aromatic diamine is at least one selected from the group consisting of 2,3,5,6-tetramethylene-1,4-phenylenediamine (Durene) having a structure of Formula 2(a) below, 3,5-diaminobenzoic acid (DABA) having a structure of Formula 2(b) below, 2,4,6-trimethyl-1,3-diaminobenzene (DAM) having a structure of Formula 2(c) below, 1,4-phenylenediamine having a structure of Formula 2(d) below, 1,3-phenylenediamine having a structure of Formula 2(e) below, 2,2-bis(4-aminophenyl)-hexafluoropropane having a structure of Formula 2(f) below, 2,3,5,6-tetrafluoro-1,4-phenylenediamine having a structure of Formula 2(g) below, and 4,4′-diaminophenyl ether having a structure of Formula 2(h) below:

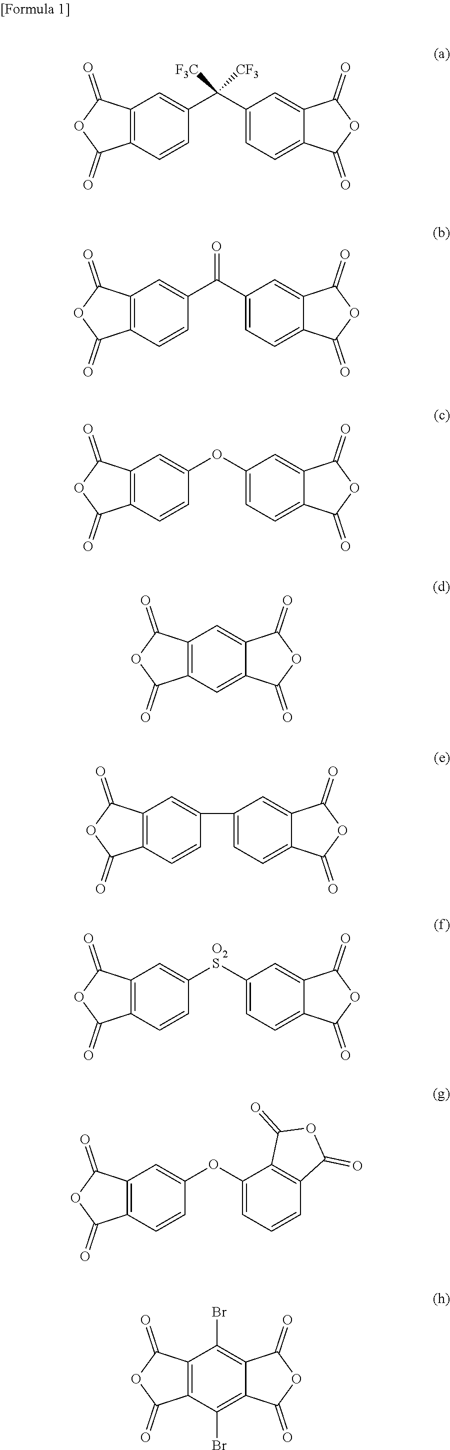

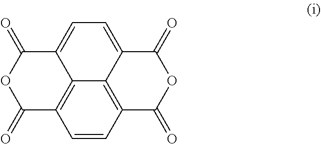 [SMILES: O=C1OC(=O)c2ccc3c4c(ccc1c24)C(=O)OC3=O]

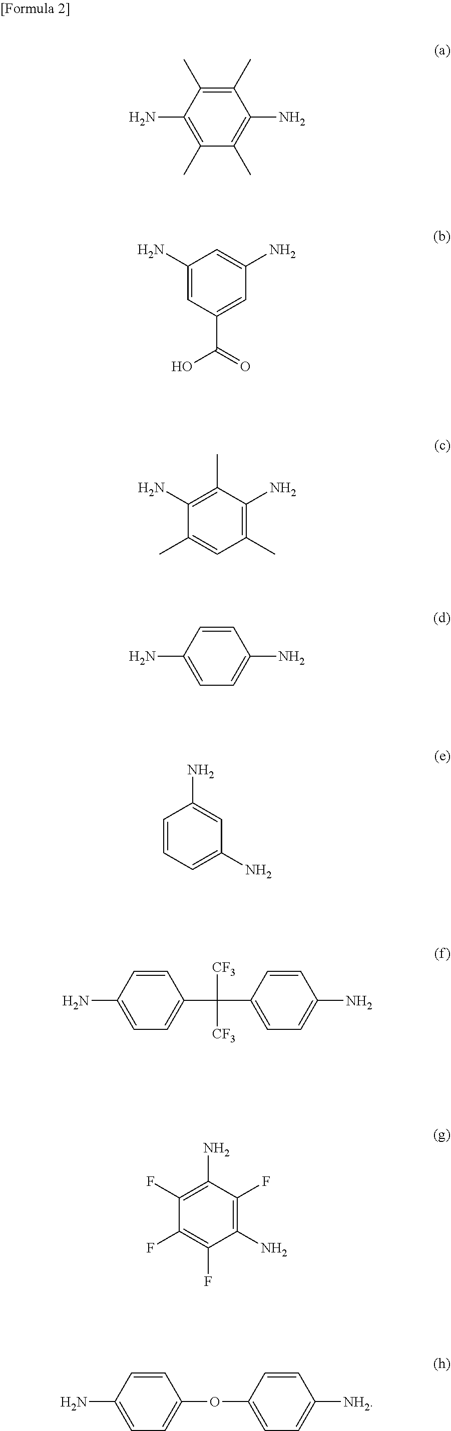

4. The polymeric hollow fiber membrane of claim 3, wherein the aromatic carboxylic dianhydride is benzophenone-3,3′,4,4′-tetracarboxylic dianhydride (BTDA), and the aromatic diamine is a mixture of 2,3,5,6-tetramethylene-1,4-phenylenediamine (Durene) and 3,5-diaminobenzoic acid (DABA).

5. The polymeric hollow fiber membrane of claim 4, wherein the polyimide is a polyimide (BTDA-Durene:DABA (3:2)) having a structure of Formula 3 below: 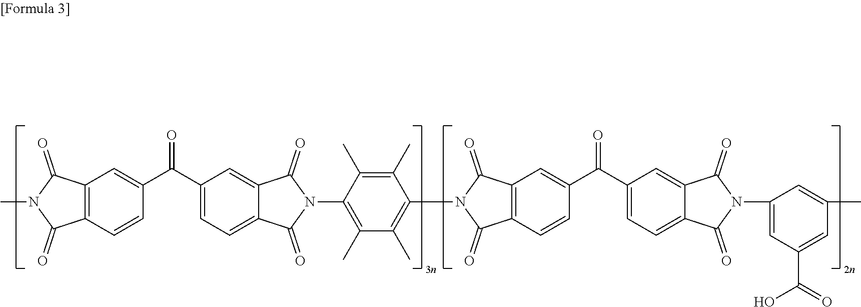
in Formula 3, n is an integer selected from 10² to 10⁴.

6. The polymeric hollow fiber membrane of claim 1, wherein the first functional group is at least one selected from the group consisting of an amine group and a carboxyl group.

7. The polymeric hollow fiber membrane of claim 1, wherein the ladder-structured polysilsesquioxane has a structure represented by the following Formula 4: 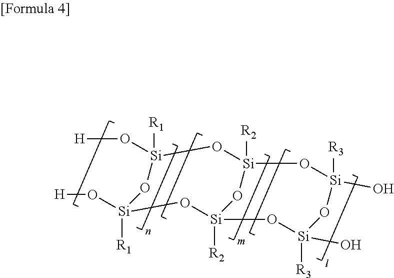
in Formula 4, R₁, R₂, and R₃ are each independently an organic functional group selected from the group consisting of aromatic phenyl, heteroaromatic phenyl, aliphatic alkyl, cycloaliphatic alkyl, vinyl, aryl, methacrylate, acrylate, and epoxy, and n, m, and 1 are each an integer selected from 0 to 100, and wherein the polysilsesquioxane has a number average molecular weight of 10² to 10⁸ g/mole.

8. The polymeric hollow fiber membrane of claim 7, wherein the ladder-structured polysilsesquioxane is selected from the group consisting of ladder-structured poly(phenyl-co-3-(2-aminoethylamino)propyl)silsesquioxane, ladder-structured poly(phenyl-co-methacryloxypropyl)silsesquioxane, ladder-structured poly(phenyl-co-glycidoxypropyl)silsesquioxane, ladder-structured poly(phenyl-co-pyridylethyl)silsesquioxane, ladder-structured poly(cyclohexyl-co-pyridylethyl)silsesquioxane, ladder-structured poly(cyclohexyl-co-phenyl-co-pyridylethyl)silsesquioxane, and a mixture thereof.

9. The polymeric hollow fiber membrane of claim 8, wherein the ladder-structured polysilsesquioxane is at least one selected from the group consisting of ladder-structured poly(phenyl-co-3-(2-aminoethylamino)propyl)silsesquioxane (LPDA64) represented by the following Formula 4a; ladder-structured poly(phenyl-co-methacryloxypropyl)silsesquioxane (LPMA64) represented by the following Formula 4b, ladder-structured poly(phenyl-co-glycidoxypropyl)silsesquioxane (LPG64) represented by the following Formula 4c, ladder-structured poly(phenyl-co-pyridylethyl)silsesquioxane (LPPyr64) represented by the following Formula 4d, ladder-structured poly(cyclohexyl-co-pyridylethyl)silsesquioxane (LCPyr64) represented by the following Formula 4e, and ladder-structured poly(cyclohexyl-co-phenyl-co-pyridylethyl)silsesquioxane (LCPPyr334) represented by the following Formula 4f:

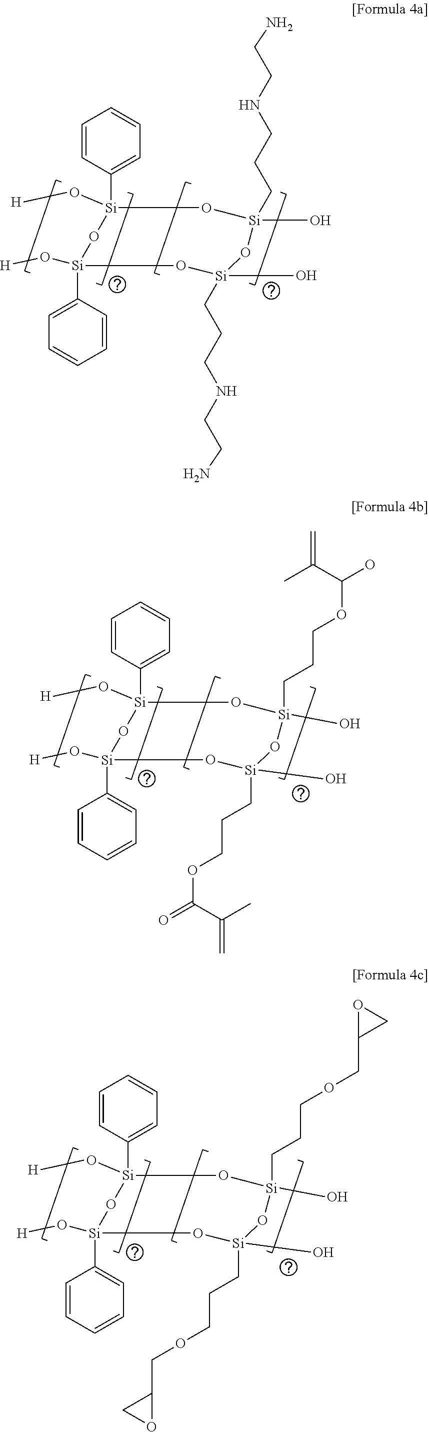

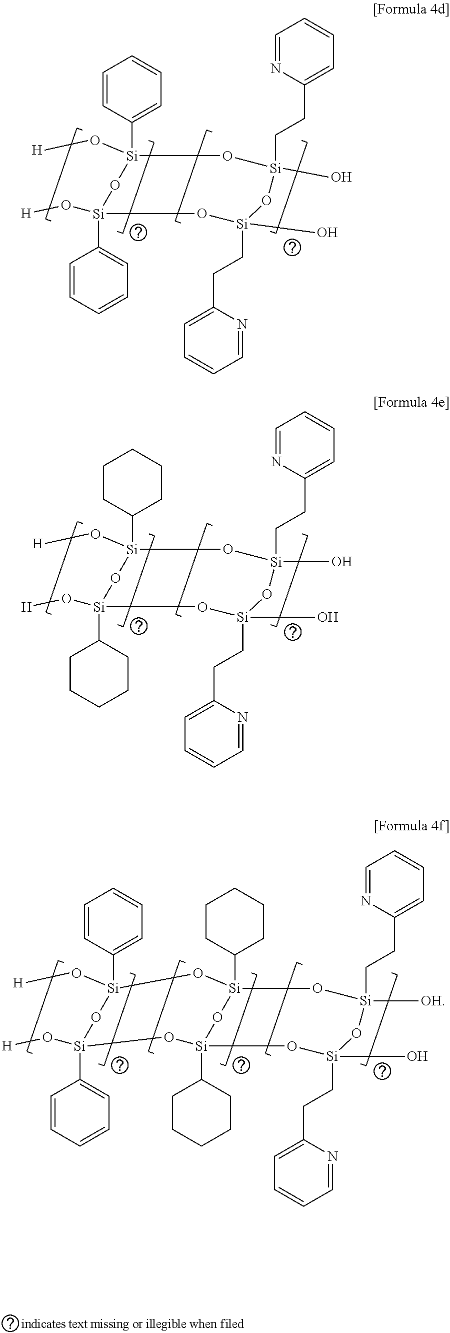

10. The polymeric hollow fiber membrane of claim 1, wherein the second functional group is at least one selected from the group consisting of an amine group and an epoxy group.

11. The polymeric hollow fiber membrane of claim 1, wherein the first functional group is a carboxyl group and the second functional group is an amine group, or the first functional group is an amine group and the second functional group is an epoxy group, and wherein 70 to 100% of each of the first functional group and the second functional group participates in the crosslinking reaction.

12. The polymeric hollow fiber membrane of claim 11, wherein the polyimide precursor comprises a polyamic acid.

13. The polymeric hollow fiber membrane of claim 1, wherein the polymeric hollow fiber membrane has an outer diameter of 200 to 400 μm and an inner diameter of 100 to 200 μm, and wherein the selective layer has a thickness of 100 nm to 3 μm.

14. A carbon molecular sieve hollow fiber membrane, which comprises a carbonized product of a polymeric hollow fiber membrane comprising:
a crosslinked polymeric hollow fiber membrane support prepared from a polymer composition comprising 70 to 95% by weight of a glassy polymer having a first functional group and 5 to 30% by weight of a ladder-structured polysilsesquioxane having a second functional group capable of reacting with the first functional group; and
a crosslinked selective layer formed on the crosslinked polymeric hollow fiber support,
wherein the carbon molecular sieve hollow fiber membrane is prepared by a method comprising:
(1) dissolving the polymer composition in an organic solvent to prepare a polymer solution; (2) spinning the polymer solution obtained in step (1) and a bore fluid through a spinneret to form a polymeric hollow fiber membrane precursor; (3) thermally treating the polymeric hollow fiber membrane precursor obtained in step (2) to form the crosslinked polymeric hollow fiber membrane support; (4) coating a polyimide precursor solution on the surface of the crosslinked polymeric hollow fiber membrane support obtained in step (3); (5) drying the polymeric hollow fiber membrane support coated in step (4) and thermally condensing and thermally crosslinking it to obtain the polymeric hollow fiber membrane; and (6) pyrolyzing the polymeric hollow fiber membrane obtained in step (5).

15. The carbon molecular sieve hollow fiber membrane of claim 14, wherein the carbon molecular sieve hollow fiber membrane has an outer diameter of 100 to 300 μm and an inner diameter of 75 to 150 μm.
